(19) United States
(12) Patent Application Publication
(10) Pub. No.: US 2024/0388346 A1
(43) Pub. Date: Nov. 21, 2024

(54) ANTENNA ADAPTATION ACCORDING TO CHANNEL STATE INFORMATION REFERENCE SIGNAL RESOURCE MANAGEMENT

(71) Applicant: QUALCOMM INCORPORATED, San Diego, CA (US)

(72) Inventors: Hung Dinh Ly, San Diego, CA (US); Yu Zhang, San Diego, CA (US)

(21) Appl. No.: 18/686,368

(22) PCT Filed: Oct. 15, 2021
(86) PCT No.: PCT/CN2021/123971

§ 371 Date: Feb. 23, 2024

(51) Int. Cl. H04B 7/06

(52) U.S. Cl. CPC H04B 7/0626; H04B 7/0658

(57) ABSTRACT

Methods, systems, and devices for wireless communication are described. A communication device may receive first control signaling indicating a channel state information (CSI) reporting configuration for a set of channel state information reference signal (CSI-RS) resources that correspond to a first number of antenna ports for the set of CSI-RS resources. The communication device may receive second control signaling indicating an antenna port configuration for a second number of antenna ports that is less than the first number of antenna ports. The second number of antenna ports may correspond to CSI-RS transmissions. The communication device may transmit feedback information based on the first control signaling and the second control signaling.

### CROSS REFERENCE

The present Application is a 371 national stage filing of International PCT Application No. PCT/CN2021/123971 by Ly et al. entitled “ANTENNA ADAPTATION ACCORDING TO CHANNEL STATE INFORMATION REFERENCE SIGNAL RESOURCE MANAGEMENT,” filed Oct. 15, 2021, which is assigned to the assignee hereof, and which is expressly incorporated by reference in its entirety herein.

### FIELD OF TECHNOLOGY

The following relates to wireless communication, including antenna adaptation according to channel state information reference signal (CSI-RS) resource management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

Various aspects of the present disclosure relate to enabling a communication device (e.g., a UE) to support managing resources according to a change in an antenna configuration, which may correspond to a number of antenna panels associated with a number of antenna ports. In some examples, the communication device may support managing CSI-RS resources according to a reduced number of antenna ports for CSI measurement and CSI reporting. The communication device may receive, via control signaling, a CSI reporting configuration, which may indicate a set of CSI-RS resources that correspond to a number of antenna ports (e.g., CSI-RS antenna ports). In some examples, the communication device may receive, control signaling, indicating the reduced number of antenna ports for CSI measurement and CSI reporting (e.g., where the reduced number of antenna ports is less than the number of antenna ports). Examples of control signaling may include a radio resource control (RRC) message, a medium access control-control element (MAC-CE), and a downlink control information (DCI).

To support CSI measurement and CSI reporting according to the reduced number of antenna ports, the communication device may declare (e.g., determine and flag or determine and indicate through signaling or transmission among other options) an error case if the reduced number of antenna ports fails to satisfy a threshold (e.g., less than a maximum number of antenna ports configured in the CSI reporting configuration). As a result, the communication device may transmit feedback information (e.g., hybrid automatic repeat request (HARQ) feedback) to the network (e.g., a base station) indicating the error case. Otherwise, the communication device may determine reduced CSI-RS resources based on the reduced number of antenna ports, and perform CSI measurement and CSI reporting. By enabling the communication device to support managing CSI-RS resources according to a reduced number of antenna ports, the communication device may, in some examples, experience improved for CSI measurement and CSI reporting, and reduce power consumption.

A method for wireless communication at a UE is described. The method may include receiving first control signaling indicating a CSI reporting configuration for a set of CSI-RS resources that correspond to a first number of antenna ports for the set of CSI-RS resources, receiving second control signaling indicating an antenna port configuration for a second number of antenna ports that is less than the first number of antenna ports, and transmitting feedback information based on the first control signaling and the second control signaling.

An apparatus for wireless communication at a UE is described. The apparatus may include a processor, memory coupled with the processor, and instructions stored in the memory. The instructions may be executable by the processor to cause the apparatus to receive first control signaling indicating a CSI reporting configuration for a set of CSI-RS resources that correspond to a first number of antenna ports for the set of CSI-RS resources, receive second control signaling indicating an antenna port configuration for a second number of antenna ports that is less than the first number of antenna ports, and transmit feedback information based on the first control signaling and the second control signaling.

Another apparatus for wireless communication at a UE is described. The apparatus may include means for receiving first control signaling indicating a CSI reporting configuration for a set of CSI-RS resources that correspond to a first number of antenna ports for the set of CSI-RS resources, means for receiving second control signaling indicating an antenna port configuration for a second number of antenna ports that is less than the first number of antenna ports, and means for transmitting feedback information based on the first control signaling and the second control signaling.

A non-transitory computer-readable medium storing code for wireless communication at a UE is described. The code may include instructions executable by a processor to receive first control signaling indicating a CSI reporting configuration for a set of CSI-RS resources that correspond to a first number of antenna ports for the set of CSI-RS resources, receive second control signaling indicating an antenna port configuration for a second number of antenna ports that is less than the first number of antenna ports, and transmit feedback information based on the first control signaling and the second control signaling.

Some examples of the method, apparatuses, and non-transitory computer-readable medium described herein may further include operations, features, means, or instructions for determining the second number of antenna ports relative to a threshold and where transmitting the feedback information may be further based on comparing the second number of antenna ports relative to the threshold.

In some examples of the method, apparatuses, and non-transitory computer-readable medium described herein, determining the second number of antenna ports relative to the threshold may include operations, features, means, or instructions for determining that the second number of antenna ports may be greater than or equal to the threshold, the threshold including a maximum number of antenna ports in a code division multiplexing (CDM) group associated with the set of CSI-RS resources and where transmitting the feedback information may be further based on determining that the second number of antenna ports may be greater than or equal to the threshold.

In some examples of the method, apparatuses, and non-transitory computer-readable medium described herein, determining the second number of antenna ports relative to the threshold may include operations, features, means, or instructions for determining that the second number of antenna ports may be greater than or equal to the threshold, the threshold including a multiple of a maximum number of antenna ports in a CDM group associated with the set of CSI-RS resources and where transmitting the feedback information may be further based on determining that the second number of antenna ports may be greater than or equal to the threshold.

Some examples of the method, apparatuses, and non-transitory computer-readable medium described herein may further include operations, features, means, or instructions for determining a subset of CSI-RS resources from the set of CSI-RS resources based on an order of CDM group indices, where the subset of CSI-RS resources corresponds to the second number of antenna ports that may be less than the first number of antenna ports, performing a CSI measurement based on the subset of CSI-RS resources, and where transmitting the feedback information may be further based on the CSI measurement.

Some examples of the method, apparatuses, and non-transitory computer-readable medium described herein may further include operations, features, means, or instructions for determining the subset of CSI-RS resources may be based on an increasing order of the CDM group indices and the increasing order begins with a lowest CDM group index and ends with a highest CDM group index.

Some examples of the method, apparatuses, and non-transitory computer-readable medium described herein may further include operations, features, means, or instructions for determining the subset of CSI-RS resources may be based on a decreasing order of the CDM group indices and the decreasing order begins with a highest CDM group index and ends with a lowest CDM group index.

Some examples of the method, apparatuses, and non-transitory computer-readable medium described herein may further include operations, features, means, or instructions for receiving third control signaling indicating a CDM group configuration, the CDM group configuration indicating the order of CDM group indices, the third control signaling including an RRC message and where determining the subset of CSI-RS resources from the set of CSI-RS resources may be further based on receiving the CDM group configuration.

Some examples of the method, apparatuses, and non-transitory computer-readable medium described herein may further include operations, features, means, or instructions for determining an order of CSI-RS antenna port indices associated with the subset of CSI-RS resources, where the order begins with a lowest CSI-RS port index in a CDM group associated with the subset of CSI-RS resources and where performing the CSI measurement may be further based on determining the order of CSI-RS antenna port indices associated with the subset of CSI-RS resources.

Some examples of the method, apparatuses, and non-transitory computer-readable medium described herein may further include operations, features, means, or instructions for determining a relationship between a set of CSI-RS antenna ports and the subset of CSI-RS resources and where performing the CSI measurement may be further based on determining the relationship between the set of CSI-RS antenna ports and the subset of CSI-RS resources.

Some examples of the method, apparatuses, and non-transitory computer-readable medium described herein may further include operations, features, means, or instructions for receiving third control signaling indicating at least one subset of antenna ports of a set of antenna ports associated with one or more subset of CSI-RS resources of the set of CSI-RS resources, the third control signaling including a MAC-CE, or a DCI, or both and performing a CSI measurement based on the one or more subset of CSI-RS resources of the set of CSI-RS resources and the at least one subset of antenna ports of the set of antenna ports.

Some examples of the method, apparatuses, and non-transitory computer-readable medium described herein may further include operations, features, means, or instructions for receiving third control signaling indicating a set of multiple subset of antenna ports of a set of antenna ports associated with one or more subset of CSI-RS resources of the set of CSI-RS resources, the third control signaling including an RRC message, receiving fourth control signaling indicating a first selection of one or more subset of antenna ports of the set of multiple subset of antenna ports, the fourth control signaling including a first MAC-CE, receiving fifth control signaling indicating a second selection of at least one subset of antenna ports of the one or more subset of antenna ports of the set of multiple subset of antenna ports, the fifth control signaling including a second MAC-CE, and where transmitting the feedback information may be further based on the second selection of at least one subset of antenna ports of the one or more subset of antenna ports of the set of multiple subset of antenna ports.

In some examples of the method, apparatuses, and non-transitory computer-readable medium described herein, one or both of the first control signaling and the second control signaling includes RRC message, a MAC-CE, or a DCI, or a combination thereof.

In some examples of the method, apparatuses, and non-transitory computer-readable medium described herein, the second number of antenna ports correspond to CSI-RS transmissions.

A method for wireless communication at a base station is described. The method may include transmitting first control signaling indicating a CSI reporting configuration for a set of CSI-RS resources that correspond to a first number of antenna ports for the set of CSI-RS resources, transmitting second control signaling indicating an antenna port configuration for a second number of antenna ports that is less than the first number of antenna ports, and receiving feedback information based on the first control signaling and the second control signaling.

An apparatus for wireless communication at a base station is described. The apparatus may include a processor, memory coupled with the processor, and instructions stored in the memory. The instructions may be executable by the processor to cause the apparatus to transmit first control signaling indicating a CSI reporting configuration for a set of CSI-RS resources that correspond to a first number of antenna ports for the set of CSI-RS resources, transmit second control signaling indicating an antenna port configuration for a second number of antenna ports that is less than the first number of antenna ports, and receive feedback information based on the first control signaling and the second control signaling.

Another apparatus for wireless communication at a base station is described. The apparatus may include means for transmitting first control signaling indicating a CSI reporting configuration for a set of CSI-RS resources that correspond to a first number of antenna ports for the set of CSI-RS resources, means for transmitting second control signaling indicating an antenna port configuration for a second number of antenna ports that is less than the first number of antenna ports, and means for receiving feedback information based on the first control signaling and the second control signaling.

A non-transitory computer-readable medium storing code for wireless communication at a base station is described. The code may include instructions executable by a processor to transmit first control signaling indicating a CSI reporting configuration for a set of CSI-RS resources that correspond to a first number of antenna ports for the set of CSI-RS resources, transmit second control signaling indicating an antenna port configuration for a second number of antenna ports that is less than the first number of antenna ports, and receive feedback information based on the first control signaling and the second control signaling.

Some examples of the method, apparatuses, and non-transitory computer-readable medium described herein may further include operations, features, means, or instructions for transmitting third control signaling indicating a CDM group configuration, the CDM group configuration indicating an order of CDM group indices.

In some examples of the method, apparatuses, and non-transitory computer-readable medium described herein, the third control signaling includes an RRC message.

Some examples of the method, apparatuses, and non-transitory computer-readable medium described herein may further include operations, features, means, or instructions for transmitting third control signaling indicating at least one subset of antenna ports of a set of antenna ports associated with one or more subset of CSI-RS resources of the set of CSI-RS resources.

In some examples of the method, apparatuses, and non-transitory computer-readable medium described herein, the third control signaling includes a MAC-CE, or a DCI, or both.

Some examples of the method, apparatuses, and non-transitory computer-readable medium described herein may further include operations, features, means, or instructions for transmitting third control signaling indicating a set of multiple subset of antenna ports of a set of antenna ports associated with one or more subset of CSI-RS resources of the set of CSI-RS resources, the third control signaling including an RRC message, transmitting fourth control signaling indicating a first selection of one or more subset of antenna ports of the set of multiple subset of antenna ports, the fourth control signaling including a MAC-CE, transmitting fifth control signaling indicating a second selection of at least one subset of antenna ports of the one or more subset of antenna ports of the set of multiple subset of antenna ports, the fifth control signaling including a second MAC-CE, and where receiving the feedback information may be further based on the second selection of at least one subset of antenna ports of the one or more subset of antenna ports of the set of multiple subset of antenna ports.

In some examples of the method, apparatuses, and non-transitory computer-readable medium described herein, one or both of the first control signaling and the second control signaling includes RRC message, a MAC-CE, or a DCI, or a combination thereof.

In some examples of the method, apparatuses, and non-transitory computer-readable medium described herein, the second number of antenna ports correspond to CSI-RS transmissions.

### BRIEF DESCRIPTION OF THE DRAWINGS

FIGS. 1 and 2 illustrate examples of wireless communications systems that support antenna adaptation according to CSI-RS resource management in accordance with aspects of the present disclosure.

FIG. 3 illustrates an example of a CSI reporting configuration framework that supports antenna adaptation according to CSI-RS resource management in accordance with aspects of the present disclosure.

FIGS. 4A and 4B illustrate examples of CSI reporting configuration frameworks that support antenna adaptation according to CSI-RS resource management in accordance with aspects of the present disclosure.

FIG. 5 illustrates an example of a CSI reporting configuration framework that supports antenna adaptation according to CSI-RS resource management in accordance with aspects of the present disclosure.

FIG. 6 illustrates an example of a process flow that supports antenna adaptation according to CSI-RS resource management in accordance with aspects of the present disclosure.

FIGS. 7 and 8 show block diagrams of devices that support antenna adaptation according to CSI-RS resource management in accordance with aspects of the present disclosure.

FIG. 9 shows a block diagram of a communications manager that supports antenna adaptation according to CSI-RS resource management in accordance with aspects of the present disclosure.

FIG. 10 shows a diagram of a system including a device that supports antenna adaptation according to CSI-RS resource management in accordance with aspects of the present disclosure.

FIGS. 11 and 12 show block diagrams of devices that support antenna adaptation according to CSI-RS resource management in accordance with aspects of the present disclosure.

FIG. 13 shows a block diagram of a communications manager that supports antenna adaptation according to CSI-RS resource management in accordance with aspects of the present disclosure.

FIG. 14 shows a diagram of a system including a device that supports antenna adaptation according to CSI-RS resource management in accordance with aspects of the present disclosure.

FIGS. 15 through 19 show flowcharts illustrating methods that support antenna adaptation according to CSI-RS resource management in accordance with aspects of the present disclosure.

### DETAILED DESCRIPTION

A communication device may be configured with one or more antenna panels to support wireless communications with multiple other communication devices, for example, in a multiple-input multiple output (MIMO) deployment. The communication device may support CSI measurement and CSI reporting on the one or more antenna panels, such as to provide low latency or high reliability wireless communications with other communication devices. For example, the communication device may perform CSI measurement and CSI reporting on resources configured for the communication device. The CSI measurement and CSI reporting may occur on CSI-RS resources, which may correspond to the one or more antenna panels. In some cases, the communication device may enable (e.g., power ON, move to a higher power state) or disable (e.g., power OFF, move to a lower power state) one or more antenna panels for energy efficiency. In some cases, when the communication device disables one or more of the antenna panels, appropriate CSI-RS resource management may be desirable.

Various aspects of the present disclosure relate to enabling a communication device (e.g., a UE) to support managing resources according to a change in an antenna configuration. The communication device may support CSI measurement and CSI reporting using a number of antenna panels, which may be associated with a number of antenna ports. In some examples, the communication device may support managing CSI-RS resources according to a reduced number of antenna ports for CSI measurement and CSI reporting. The communication device may receive, via control signaling, a CSI reporting configuration, which may indicate a set of CSI-RS resources that correspond to the number of antenna ports (e.g., CSI-RS antenna ports). In some examples, the communication device may receive control signaling indicating the reduced number of antenna ports for CSI measurement and CSI reporting. Examples of the control signaling may include an RRC message, a MAC-CE, or a DCI, or any combination thereof.

To support CSI measurement and CSI reporting according to the reduced number of antenna ports, the communication device may declare (e.g., determine, indicate) an error case if the reduced number of antenna ports fails to satisfy a threshold (e.g., less than a maximum number of antenna ports configured in the CSI reporting configuration). As a result, the communication device may transmit feedback information (e.g., HARQ feedback) to the network (e.g., a base station) indicating the error case. Otherwise, the communication device may determine reduced CSI-RS resources based on the reduced number of antenna ports, and perform CSI measurement and CSI reporting. By enabling the communication device to support managing CSI-RS resources according to the reduced number of antenna ports, the communication device may experience improved for CSI measurement and CSI reporting, and, in some examples, reduce power consumption.

Particular aspects of the subject matter described in this disclosure may be implemented to realize the following potential advantages. The techniques described herein may provide improvements to CSI measurement and CSI reporting. For example, a communication device may improve the signaling efficiency and accuracy of CSI measurement and CSI reporting operations by adapting to one or more changes in number of antenna ports (e.g., reduced CSI-RS ports) for CSI measurement and CSI reporting. Performing CSI measurement and CSI reporting operations with improved signaling efficiency and accuracy may increase the reliability and decrease latency for CSI measurement and CSI reporting, among other benefits.

Aspects of the disclosure are initially described in the context of wireless communications systems. Aspects of the disclosure are further illustrated by and described with reference to apparatus diagrams, system diagrams, and flowcharts that relate to antenna adaptation according to CSI-RS resource management.

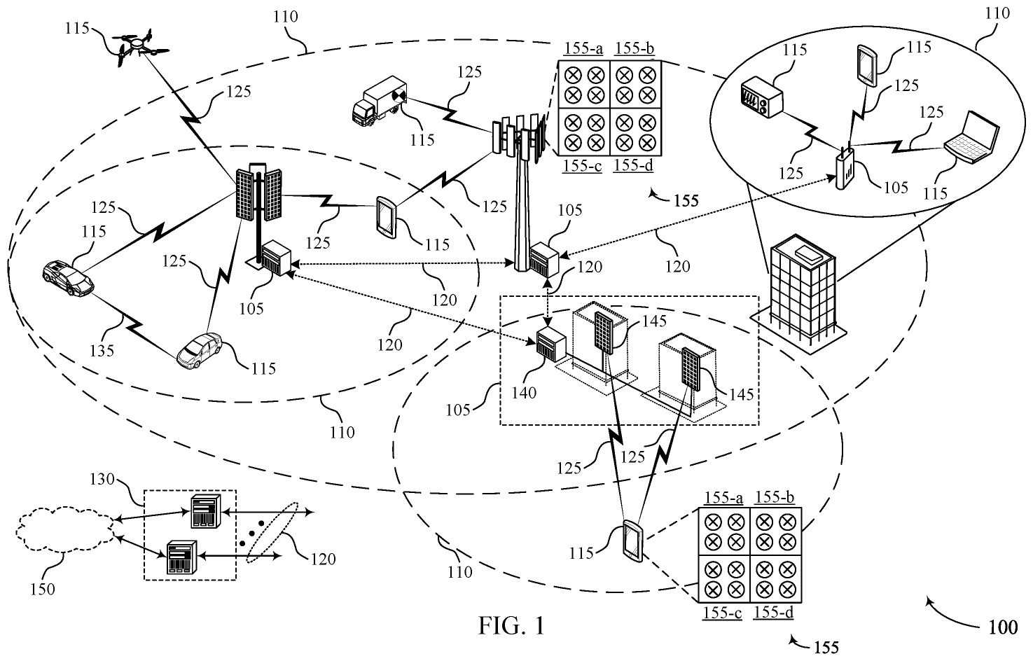

FIG. 1 illustrates an example of a wireless communications system 100 that supports antenna adaptation according to CSI-RS resource management in accordance with aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may be associated with a bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ne may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS, which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Some network operators of the wireless communications system 100 may have increasing concerns for power consumption by communication devices (e.g., base stations 105, UEs 115, or the like) of the wireless communications system 100. In the wireless communications system 100, power consumption by communication devices (e.g., base stations 105, UEs 115, an adaptive antenna unit (AAU), a remote radio unit (RRU), a baseband unit (BBU), or the like) may be influenced by bandwidth allocation and number of antennas used for wireless communication or radio frequency spectrum band allocation for the wireless communications. In some cases, some network operators may have increased concerns for power consumed by communication devices due to environmental factors, such as carbon emissions. Additionally, some network operators may have increased concerns for power consumed by communication devices because of network energy efficiency concerns for the wireless communications system 100.

The wireless communications system 100 may support massive-MIMO (mMIMO) operations to increase throughput (e.g., transmissions) by utilizing multiple co-located antenna panels, which may be referred to a transmission-reception points (TRPs). For example, one or both of base stations 105 or UEs 115 in the wireless communications system 100 may be configured with a set of antenna panels 155 (e.g., co-located antenna panels) and may support mMIMO operations by utilizing the set of antenna panels 155. Each antenna panel 155 may be associated with a set of antenna ports, which may include one or more antenna ports, and be equipped with a number of power amplifiers (PAs) and other antenna circuit elements (e.g., other antenna subsystems), which might consume significant amount of power. In some cases, one or both of base stations 105 or UEs 115 may determine to disable (e.g., power OFF) the antenna panel 155 or one or more sub-antenna panels (e.g., a sub-antenna panel 155-a, a sub-antenna panel 155-b, a sub-antenna panel 155-c, or a sub-antenna panel 155-c, or a combination thereof) for energy efficiency. In some cases, one or both of base stations 105 or UEs 115 may fallback to operating in a half-duplex mode (e.g., in a frequency domain), or operate in a full-duplex mode with reduced wireless communications (e.g., low traffic in a cell) to reduce power consumption.

Various aspects of the present disclosure relate to enabling a UE 115 to support managing resources according to a change in an antenna configuration. The UE 115 may support CSI measurement and CSI reporting using a number of antenna panels, which may be associated with a number of antenna ports. In some examples, the UE 115 may support managing CSI-RS resources according to a reduced number of antenna ports for CSI measurement and CSI reporting. In some examples, the UE 115 may support managing CSI-RS resources according to a reduced number of antenna ports for CSI measurement and CSI reporting. The UE 115 may receive, via control signaling, a CSI reporting configuration, which may indicate a set of CSI-RS resources that correspond to the number of antenna ports (e.g., CSI-RS antenna ports). In some examples, the UE 115 may receive, control signaling, indicating the reduced number of antenna ports for CSI measurement and CSI reporting. Examples of control signaling include an RRC message, a MAC-CE, and a DCI.

To support CSI measurement and CSI reporting according to the reduced number of antenna ports, the UE 115 may declare (e.g., determine, indicate) an error case if the reduced number of antenna ports fails to satisfy a threshold (e.g., less than a maximum number of antenna ports configured in the CSI reporting configuration). As a result, the UE 115 may transmit feedback information (e.g., HARQ feedback) to the network (e.g., a base station) indicating the error case. Otherwise, the UE 115 may determine reduced CSI-RS resources based on the reduced number of antenna ports, and perform CSI measurement and CSI reporting. By enabling the UE 115 to support managing CSI-RS resources according to a reduced number of antenna ports, the UE 115 may experience improved for CSI measurement and CSI reporting, and, in some examples, reduce power consumption.

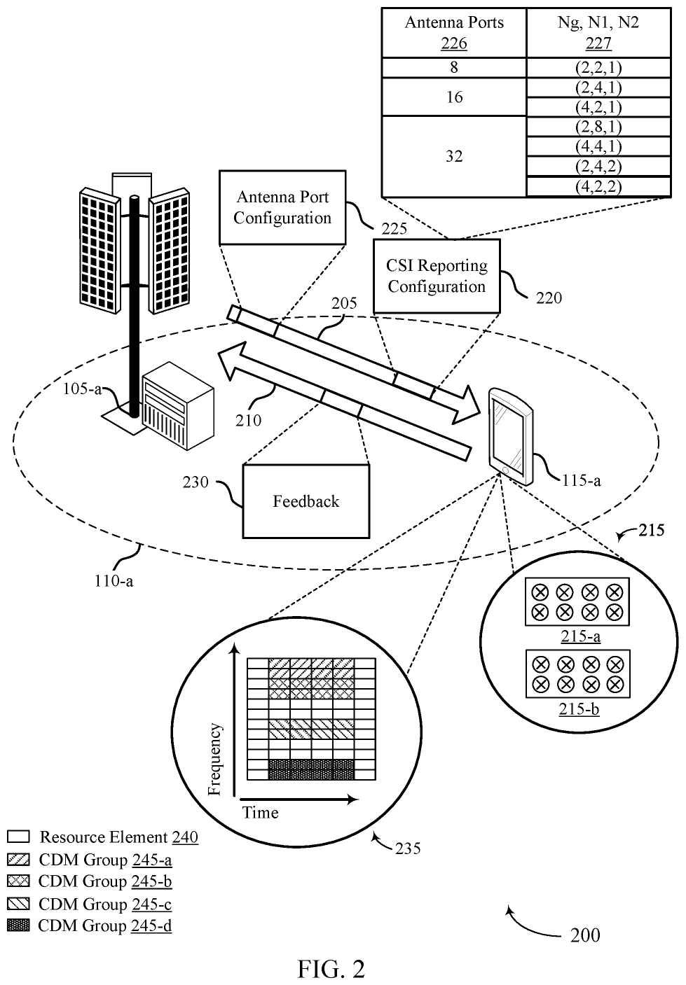

FIG. 2 illustrates an example of a wireless communications system 200 that supports antenna adaptation according to CSI-RS resource management in accordance with aspects of the present disclosure. The wireless communications system 200 may implement or be implemented by one or more aspects of the wireless communications system 100. For example, the wireless communications system 200 may include a base station 105-a and a UE 115-a, which may be examples of devices as described with reference to FIG. 1. The base station 105-a and the UE 115-a may communicate within a geographic coverage area 110-a over a communication link 205 and a communication link 210, which may be examples of geographic coverage areas 110 and communication links 125 as described with reference to FIG. 1. The wireless communications system 200 may support improvements to power consumption, higher data rates and, in some examples, may promote high reliability and low latency wireless communications, among other benefits.

The base station 105-a and the UE 115-a may support operations, such as mMIMO operations, using multiple co-located antenna panels. One or both of the base station 105-a or the UE 115-a may be equipped with multiple antenna panels, which may be used to employ techniques such as transmit diversity, receive diversity, MIMO communications, or beamforming. For example, the UE 115-a may be equipped with a set of antenna panels 215 including a first antenna panel 215-a and a second antenna panel 215-b. The antenna panels of one or both of the base station 105-a or the UE 115-a may be located within one or more antenna arrays, which may support MIMO operations or transmit or receive beamforming. The antenna panels may have an antenna array with a number of rows and columns of antenna ports that one or both of the base station 105-a or the UE 115-a may use to support wireless communications. For example, each of the first antenna panel 215-a and the second antenna panel 215-b may include one or more rows and columns of antenna ports.

In the example of FIG. 2, the UE 115-a may support CSI operations, such as CSI reporting to promote high reliability and low latency wireless communications with the base station 105-a. In some examples, the base station 105-a may transmit, and the UE 115-a may receive, a CSI reporting configuration 220. In some examples, the base station 105-a may transmit, and the UE 115-a may receive, the CSI reporting configuration 220 via an RRC message, or a MAC-CE, or a DCI, or any combination thereof. The CSI reporting may include one or more CSI parameters, which may include one or more of a channel quality indicator (CQI), a precoding matrix indicator (PMI), or a CSI-RS indicator (CRI). In some other examples, the one or more CSI parameters may include one or more of a layer indicator (LI) (e.g., a strongest layer indicator (SLI)), a rank indicator (RI), or a layer one reference signal received power (LI-RSRP) (e.g. for beam management).

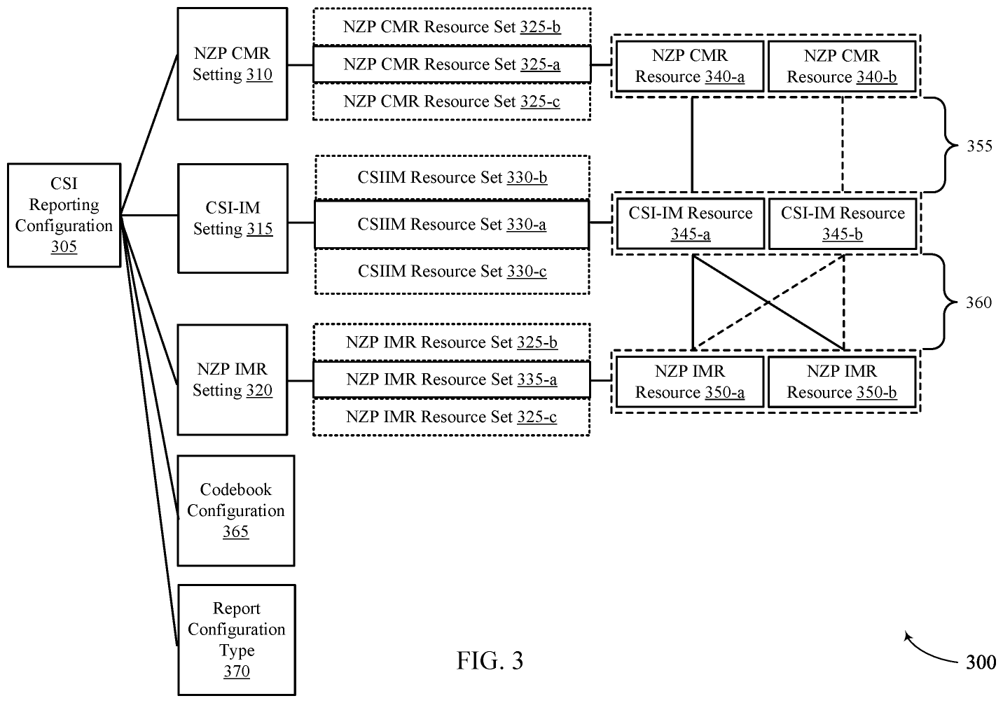

The CSI reporting configuration 220 (e.g., a higher layer configuration) may be associated with a number of CSI reporting settings (e.g., N≥1), a number of resource settings (e.g., M≥1), or a number of CSI measurement links (e.g., L≥1). The CSI reporting configuration 220 may link to one or more resource settings associated with different measurement types as described in more detail in FIG. 3. For example, the one or more resource settings may include a non-zero power (NZP) CSI-RS resource for channel measurement (CMR), a CSI-RS resource for interference measurement (CSI-IM), an NZP CSI-RS for interference measurement, or any combination thereof. As such, the CSI reporting configuration 220 may grant resources for CSI measurement and CSI reporting by the UE 115-a. In some cases, a CSI reporting setting may be associated with one or more BWPs (e.g., a downlink BWP) and may include one or more radio frequency spectrum bands for CSI reporting (e.g., a CSI reporting band). BWP information associated with a BWP (e.g., a downlink BWP) may be configured per resource setting. In some cases, all linked resource settings of a CSI reporting setting may be associated with the same BWP. In some other cases, different resource settings of a CSI reporting setting may be associated with different BWPs.

In some cases, the CSI reporting configuration 220 may indicate one or more codebooks, which may be used to map transmissions (e.g., control information or data, or both) to one or more antenna ports associated with one or more antenna panels 215. One or both of the base station 105-a or the UE 115-a may support one or more different codebook types, which may include at least a first codebook type and a second codebook type. The first codebook type may be for single antenna panel or multiple antenna panel. The second codebook type may be for single antenna panel, antenna port selection, or enhanced antenna port selection, or any combination thereof.

In some examples, one or both of the base station 105-a or the UE 115-a may support an antenna configuration for each codebook type. Each codebook type may assume certain closely spaced antenna arrangements along linear or rectangular antenna panel arrays with two cross-polarized antenna elements at each antenna panel array element. An antenna configuration may indicate a number of antenna ports 226 (e.g., CSI-RS antenna ports) including 8, 16, or 32 antenna ports. A respective codebook associated with the antenna configuration may support 8, 16, or 32 antenna ports (e.g., for CSI-RS transmission). Additionally, the antenna configuration may support a set of antenna arrangements 227, where N₁ is the number of antenna elements in the horizontal direction, N₂ is the number of antenna elements in the vertical direction, and N_{g} is the number of supported panels. The notation “horizontal” versus “vertical” represents typical arrangements, the actual orientation used is transparent to the UE 115-a. In the example of FIG. 2, the number of antenna elements N₁ may be equal to 4 (e.g., N₁=4), the number of antenna elements N₂ may be equal to 2 (e.g., N₂=2), and the number of antenna panels N_{g} may be equal 2 (e.g., N_{g}=2). As such, the UE 115-a may support 32 antenna ports, for example, for CSI-RS transmissions.

In some cases, the UE 115-a may enable (e.g., power ON) or disable (e.g., power OFF) one or more antenna panels 215 for energy efficiency. Additionally, the UE 115-a may support CSI measurement and CSI reporting on via one or more antenna ports associated with the one or more antenna panels 215, for example, to decrease latency or increase reliability of wireless communications. For example, the UE 115-a may perform CSI measurement and CSI reporting on resources configured for the UE 115-a. The CSI measurement and CSI reporting may occur on CSI-RS resources, which may correspond to the one or more antenna ports associated with the one or more antenna panels 215.

Various aspects of the present disclosure relate to one or both of the base station 105-a or the UE 115-a adapting use of CSI-RS resources in response to disabling of one or more antenna ports associated with one or more antenna panels 215 (e.g., using a reduced number of antenna ports). In some examples, one or both of the base station 105-a or the UE 115-a may support use of the same number of resources (e.g., CSI-RS resources) associated with the CSI reporting configuration 220 for normal operations and power saving operations (e.g., reduced antenna ports). In some other examples, one or both of the base station 105-a or the UE 115-a may support use of fewer resources (e.g., CSI-RS resources) associated with the CSI reporting configuration 220 for power saving operations. For example, the UE 115-a may down-select, for power saving operations, resources that are configured for normal operations.

In some examples, if a number of disabled antenna ports associated with one or more antenna panels 215 is reduced to less than a number of antenna ports configured for the UE 115-a, for example, by the base station 105-a, the UE 115-a may transmit feedback 230 to the base station 105-a indicating an error condition. Otherwise, the UE 115-a may determine unused CSI-RS resources that correspond to the disabled antenna ports, and perform CSI measurement and CSI reporting on CSI-RS resources that correspond to the enabled antenna ports. The UE 115-a may determine the CSI-RS resources (which may be referred to reduced CSI-RS resources) that correspond to the enabled antenna ports based on an order of resource group indices (e.g., code division multiplexing (CDM) groups 245) for configured CSI-RS resources. In some examples, the order may be an increasing order or a decreasing order of CDM group indices.

A CDM group size in a time domain may be 1, 2, or 4. A CDM group 245 may be a group of two or more resource elements 240. In the example of FIG. 2, the UE 115-a may support CSI-RS resources with 32 antenna ports of 4 CDM groups including a CDM group 245-a including two or more resource elements, a CDM group 245-b including two or more resource elements, a CDM group 245-c including two or more resource elements, and a CDM group 245-d including two or more resource elements. In some examples, an orthogonal cover code in a CDM group 245 may be one-dimensional binary Walsh codes or two-dimensional binary Walsh codes. In some cases, if the number of antenna ports is reduced to less than the number of antenna ports in a CDM group 245, the truncated orthogonal cover codes in the CDM group 245 may not be orthogonal.

In the example of FIG. 2, the UE 115-a may receive control signaling (e.g., an RRC message, a MAC-CE, a DCI) indicating the CSI reporting configuration 220 for a set of CSI-RS resources that correspond to a first number of antenna ports for the set of CSI-RS resources. The UE 115-a may receive additional control signaling (e.g., an RRC message, a MAC-CE, a DCI) indicating an antenna port configuration 225 for a second number of antenna ports that is less than the first number of antenna ports. The UE 115-a may transmit feedback information (e.g., HARQ information) based on the CSI reporting configuration 220 and the antenna port configuration 225.

The UE 115-a may declare (e.g., determine, indicate) an error condition (also referred to as an “error case”) based on determining the second number of antenna ports relative to a threshold (e.g., a threshold number of antenna ports). In some examples, the UE 115-a may determine an error case if a number of antenna ports is not reduced to less than a maximum number of antenna ports in a CDM group 245 of a CSI-RS resource configured in the CSI reporting configuration 220. For example, for a CSI-RS resource with 32 antenna ports using 4 CDM groups, the minimum number of antenna ports that can be reduced to is 8 antenna ports. In some other examples, the UE 115-a may determine an error case if a number of antenna ports that can be reduced to is a multiple of a maximum number of antenna ports in a CDM group 245 of a CSI-RS resource configured in the CSI reporting configuration 220. For example, for CSI-RS resource with 32 antenna ports using 4 CDM groups, the number of antenna ports that can be reduced to can be one value from 8 antenna ports, 16 antenna ports, 24 antenna ports, or 32 antenna ports.

The UE 115-a may be configured to determine CSI-RS resources to use for CSI measurement based on a CSI resource configuration provided in the CSI reporting configuration 220, if a number of antenna ports is reduced to less than the number of antenna ports configured by the CSI reporting configuration 220. The UE 115-a may determine a subset of CSI-RS resource from the set of CSI-RS resources to use for CSI measurement and CSI reporting based on an order of CDM group indices associated with the CDM groups 245. That is, the UE 115-a may determine reduced CSI-RS resources corresponding to the reduced antenna port configuration for CSI measurement and CSI reporting based on an order of CDM group indices associated with the CDM groups 245.

The UE 115-a may determine the reduced CSI-RS resources corresponding to the reduced antenna port configuration for CSI measurement and CSI reporting based on an increasing order of the CDM group indices starting from a CDM group index 0. For example, for CSI-RS resource with 32 antenna ports using 4 CDM groups, if the antenna port configuration 225 is reduced to 8 antenna ports, the CSI-RS resource in the CDM group 245-a (e.g., CDM group #0) is used for CSI measurement. Alternatively, the UE 115-a may determine the reduced CSI-RS resources corresponding to the reduced antenna port configuration for CSI measurement and CSI reporting based on a decreasing order of the CDM group indices starting from a CDM group index 4. For example, for CSI-RS resource with 32 antenna ports using 4 CDM groups, if the antenna port configuration 225 is reduced to 8 antenna ports, the CSI-RS resource in the CDM group 245-d (e.g., CDM group #4) is used for CSI measurement.

Additionally or alternatively, the network (e.g., the base station 105-a) may configure the CDM group 245 indices (e.g., index 0 and index 3 for 16 antenna ports). If the CDM group 245 indices are not configured by the network (e.g., the base station 105-a), the UE 115-a may fallback on determining the reduced CSI-RS resources based on the increasing or decreasing order of CDM group indices. The UE 115-a may be configured via an RRC configuration message to determine the reduced CSI-RS resources based on one or both of the increasing order of the CDM group indices or the decreasing order of the CDM group indices.

The UE 115-a may be configured to renumber (e.g., order) the reduced antenna ports (e.g., reduced CSI-RS antenna ports). For example, the UE 115-a may determine an order of CSI-RS antenna port indices associated with the subset of CSI-RS resources. In some examples, when antenna ports (e.g., CSI-RS antenna ports) are reduced, the antenna port indices may start from the lowest CSI-RS port indices in the reduced CDM groups. That is, the order may begin with a lowest CSI-RS port index in a CDM group 245 associated with the subset of CSI-RS resources. The UE 115-a may also determine a relationship between a set of CSI-RS antenna ports and the subset of CSI-RS resources based on a reduction of one or more CDM groups 245.

The operations performed by the base station 105-a and the UE 115-a, for example, may thus provide improvements to CSI measurement and CSI reporting in the wireless communications system 200. Additionally, the operations performed by the base station 105-a and the UE 115-a may provide improvements to the operation of the UE 115-a. For example, by supporting antenna adaptation according to CSI-RS resource management in the wireless communications system 200, various operational characteristics, such as power consumption by the UE 115-a, may be reduced. The operations performed by the base station 105-a and the UE 115-a may also promote efficiency of the UE 115-a by reducing latency associated with processes related to high reliability and low latency wireless communications (such as, MIMO communications).

FIG. 3 illustrates an example of a CSI reporting configuration framework 300 that supports antenna adaptation according to CSI-RS resource management in accordance with aspects of the present disclosure. The CSI reporting configuration framework 300 may implement or be implemented by one or more aspects of the wireless communications system 100 and the wireless communication system 200 as described in FIGS. 1 and 2, respectively. For example, the CSI reporting configuration framework 300 may be implemented by a base station 105 and a UE 115 in a CSI reporting procedure, as described with reference to FIGS. 1 and 2.

The CSI reporting configuration framework 300 may illustrate a process in which the UE 115 receives a CSI reporting configuration 305 from the network (e.g., from the base station 105) that may indicate one or more resources to use for a CSI measurement. The CSI reporting configuration 305 may implement or be implemented by one or more aspects of the CSI reporting configuration 220 as described in FIG. 1. For example, the UE 115 may receive a control message indicating the CSI reporting configuration 305 corresponding to one or more resources (e.g., CSI measurement resources) over which the UE 115 may monitor for one or more reference signals. For example, the UE 115 may receive the control message, such as an RRC message, a MAC-CE, a DCI, or the like, including the CSI reporting configuration 305 (which may be equivalently referred to as a “CSI report config”) that may link to one or more resource settings associated with different measurement types.

The CSI reporting configuration 305 may link to a setting for one or more of a non-zero power (NZP) CSI-RS resource for channel measurement (CMR) 310, a CSI-RS resource for interference measurement (CSI-IM) 315, an NZP CSI-RS for interference measurement (NZP IMR) 320, or any combination thereof. Each resource setting of the one or more resource settings to which the CSI reporting configuration 305 links may be associated with multiple resources sets, but one active resource set (e.g., one active resource set). Additionally, or alternatively, the CSI reporting configuration 305 may link to a codebook configuration 365 or a report configuration type 370 (e.g., periodic, semi-persistent, aperiodic). In some examples, the UE 115 may perform periodic CSI reporting (e.g., the base station 105 may transmit higher layer signaling scheduling periodic CSI reports), aperiodic CSI reporting (e.g., the base station 105 may dynamically configure a CSI report), semi-persistent CSI reporting (e.g., the base station 105 may transmit higher layer signaling scheduling periodic CSI reports and may use dynamic signaling to trigger the periodic CSI reporting), or a combination.

The NZP-CMR setting 310 may be associated with one or more NZP CMR resource sets 325. For example, an NZP CMR resource set 325-a may be an active resource set, while an NZP CMR resource set 325-b and an NZP CMR resource set 325-c may be inactive resource sets. Similarly, the CSI-IM resource setting 315 may be associated with one or more CSI-IM resource set 330. For example, a CSI-IM resource set 330-a may be an active resource set, while a CSI-IM resource set 330-b and a CSI-IM resource sets 330-c may be inactive resource sets. Similarly, the NZP IMR setting 320 (e.g., NZP CSI-RS resource configuration for interference measurement) may be associated with one or more NZP IMR resource sets 335. For example, an NZP IMR Resource set 335-a may be an active resource set, while an NZP IMR Resource set 335-b and an NZP IMR Resource set 335-c may be inactive resource sets.

Each resource set may have one or more resources, which may be referred to as CSI-RS resources or CSI measurement resources. For example, the NZP CMR resource set 325-a may include one or more resources, such as one or more NZP CMR resources 340 (e.g., an NZP CMR resource 340-a and an NZP CMR resource 340-b). In some examples, the NZP CMR resource 340-a may be associated with a transmission configuration indicator (TCI) state a1 (e.g., a first TCI state) and the NZP CMR resource 340-b may be associated with a TCI state a2 (e.g., a second TCI state). Similarly, the CSI-IM resource set 330-a may include one or more resources, such as one or more CSI-IM resources 345 (e.g., a CSI-IM resource 345-a associated with a TCI state b1 (e.g., a first TCI state) and a CSI-IM resource 345-b associated with a TCI state b2 (e.g., a second TCI state)). Similarly, the NZP IMR resource set 335-a may include one or more resources, such as one or more NZP IMR resources 350 (e.g., an NZP IMR resource 350-a associated with a TCI state c1 (e.g., a first TCI state) and an NZP IMR resource 350-b associated with a TCI state c2 (e.g., a second TCI state)).

Each CSI measurement resource within a resource set may be referred to as a CSI hypothesis. As illustrated, in the CSI reporting configuration framework 300, there may be a one-to-one mapping between each CMR or each CSI hypothesis (e.g., each CRI), and each CSI-IM resource. In other words, each CSI-RS resource for CSI measurement may be resource-wise associated with a CSI-IM resource based in part on the ordering of the CSI-RS resource and the CSI-IM resource in the corresponding resource set. The number of CSI-RS resources for CSI measurement may be equal to the number of CSI-IM resources. In some examples, the UE 115 may measure an interference by measuring the energy in the CSI-IM resource. A CSI-IM resource configuration might include resource elements for the UE 115 to measure the interference. Each CMR resource may be associated with all IMR resources.

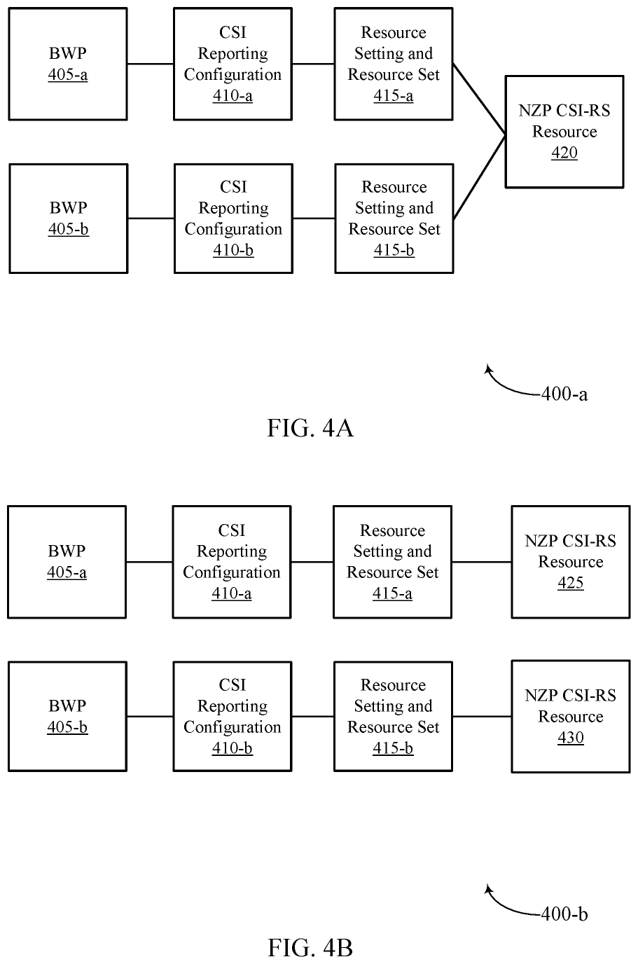

FIG. 4A illustrates an example of a CSI reporting configuration framework 400-a that supports antenna adaptation according to CSI-RS resource management in accordance with aspects of the present disclosure. The CSI reporting configuration framework 400-a may implement or be implemented by one or more aspects of the wireless communications system 100 and the wireless communication system 200 as described in FIGS. 1 and 2, respectively. For example, the CSI reporting configuration framework 400-a may be implemented by a base station 105 and a UE 115 in a CSI reporting procedure, as described with reference to FIGS. 1 and 2. In the example of FIG. 4A, the CSI reporting configuration framework 400-a may support a common CSI-RS resource for different BWPs.

The CSI reporting configuration framework 400-a may include a first BPW 405-a and a second BWP 405-b. The first BWP 405-a may link to a first CSI reporting configuration 410-a (e.g., “a CSI report config 0”), while the second BWP 405-b may link to a second CSI reporting configuration 410-b (e.g., “a CSI report config 1”). As such, a CSI reporting configuration may be configured per BWP. The first CSI reporting configuration 410-a (e.g., “a CSI report config 0”) may link to a first resource setting and resource set 415-a, while the second CSI reporting configuration 410-b (e.g., “a CSI report config 1”) may link to a second resource setting and resource set 415-b.

In the example of FIG. 4A, the first resource setting and resource set 415-a and the second resource setting and resource set 415-b may link an NZP CSI-RS resource 420 (e.g., associated with 32 antenna ports). As such, CSI-RS resource for CSI measurement might not be BWP specific. In other words, CSI measurement can be performed by a UE on the CSI-RS resource that is common for multiple BWPs. By supporting a common CSI-RS resource for different BWPs, a UE 115 may reduce CSI-RS resource overhead for channel state feedback (CSF). As such, when the UE 115 determines CSI, the UE 115 may perform CSI reporting on the CSI-RS resource within a BWP linked to the CSI reporting.

FIG. 4B illustrates an example of a CSI reporting configuration framework 400-b that supports antenna adaptation according to CSI-RS resource management in accordance with aspects of the present disclosure. The CSI reporting configuration framework 400-b may implement or be implemented by one or more aspects of the wireless communications system 100 and the wireless communication system 200 as described in FIGS. 1 and 2, respectively. For example, the CSI reporting configuration framework 400-b may be implemented by a base station 105 and a UE 115 in a CSI reporting procedure, as described with reference to FIGS. 1 and 2. In the example of FIG. 4B, the CSI reporting configuration framework 400-b may support separate CSI-RS resources for different BWPs.

The CSI reporting configuration framework 400-b may include a first BPW 405-a and a second BWP 405-b. The first BWP 405-a may link to a first CSI reporting configuration 410-a (e.g., “a CSI report config 0”), while the second BWP 405-b may link to a second CSI reporting configuration 410-b (e.g., “a CSI report config 1”). As such, a CSI reporting configuration may be configured per BWP. The first CSI reporting configuration 410-a (e.g., “a CSI report config 0”) may link to a first resource setting and resource set 415-a, while the second CSI reporting configuration 410-b (e.g., “a CSI report config 1”) may link to a second resource setting and resource set 415-b.

In the example of FIG. 4B, the first resource setting and resource set 415-a and the second resource setting and resource set 415-b may link to different NZP CSI-RS resources. For example, the first resource setting and resource set 415-a may link to an NZP CSI-RS resource 425 (e.g., associated with 32 antenna ports), while the second resource setting and resource set 415-b may link to an NZP CSI-RS resource 430 (e.g., associated with 8 antenna ports). As such, CSI-RS resource for CSI measurement might be BWP specific. In other words, CSI measurement can be performed by a UE on separate CSI-RS resources that are separate for different BWPs. By supporting separate CSI-RS resources for different BWPs, the network (e.g., the base station 105) may implement dynamic antenna adaptation via dynamic BWP switching mechanism. However, in some cases, by supporting separate CSI-RS resources for different BWPs, CSI resource overhead might be higher than when the UE 115 supports common CSI-RS resources for different BWPs as described in FIG. 4A.

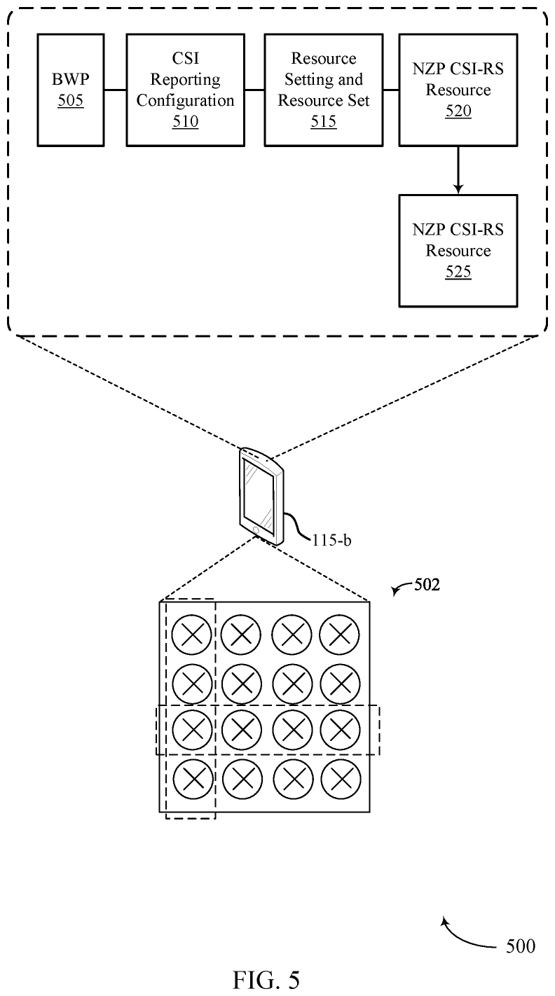

FIG. 5 illustrates an example of a CSI reporting configuration framework 500 that supports antenna adaptation according to CSI-RS resource management in accordance with aspects of the present disclosure. The CSI reporting configuration framework 500 may implement or be implemented by one or more aspects of the wireless communications system 100 and the wireless communication system 200 as described in FIGS. 1 and 2, respectively. For example, the CSI reporting configuration framework 500 may be implemented by a UE 115-b in a CSI reporting procedure, as described with reference to FIGS. 1 and 2.

In the example of FIG. 5, the UE 115-b may support antenna configuration 502 where the number of antenna elements N₁ may be equal to 4 (e.g., N₁=4), the number of antenna elements N₂ may be equal to 4 (e.g., N₂=4), and the number of antenna panels N_{g} may be equal 1 (e.g., N_{g}=1). As such, the UE 115-b may support 32 antenna ports as described with reference to FIG. 2. The CSI reporting configuration framework 500 may support reduced antenna ports for CSI measurement and CSI reporting. The CSI reporting configuration framework 500 may be associated with a BPW 505. The BWP 505may link to a CSI reporting configuration 510 (e.g., “a CSI report config 0”). The CSI reporting configuration 510 (e.g., “a CSI report config 0”) may link to a resource setting and resource set 515. The resource setting and resource set 515 may link to an NZP CSI-RS resource 520, which may be associated with 32 antenna ports. The NZP CSI-RS resource 520 may be RRC configured as part of the CSI reporting configuration 510.

In some examples, the base station 105 may transmit, and the UE 115-b may receive, an indication of a subset of antenna ports from the RRC-configured antenna ports for the NZP CSI-RS resource 520 via a MAC-CE or a DCI. For example, the base station 105 may transmit, and the UE 115-b may receive, an indication of a reduced number of antenna ports (e.g., 8 antenna ports) for NZP CSI-RS resource 525 (which may be the same as the NZP CSI-RS resource 520) via a MAC-CE or a DCI. As such, the NZP CSI-RS resource may be the same but associated with the reduced number of antenna ports (e.g., 8 antenna ports). The UE 115-b may perform CSI measurement and CSI reporting based on the configured CSI-RS resource (e.g., NZP CSI-RS resource) from the CSI reporting configuration 510 and the indicated reduced number of antenna ports via the MAC-CE or the DCI.

Additionally or alternatively, the base station 105 may transmit, and the UE 115-b may receive, an indication of K subsets of antenna ports selected from the RRC-configured N antenna ports for a CSI-RS resource (e.g., NZP CSI-RS resource). In some examples, the base station 105 may transmit, and the UE 115-b may receive, via a MAC-CE, an indication to down-select L subsets of antenna ports from the K subsets of antenna ports. In some examples, the base station 105 may transmit, and the UE 115-b may receive, via a DCI, an indication to select a value from the L subsets of antenna ports.

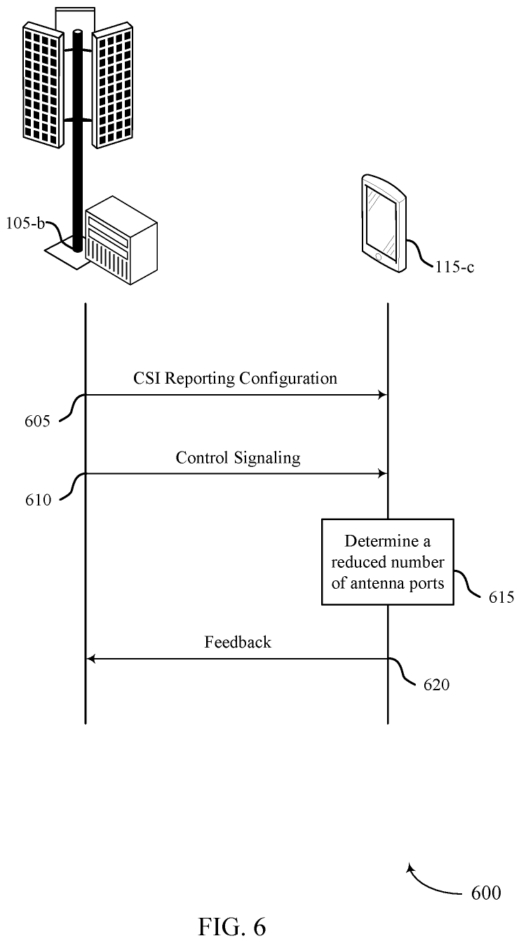

FIG. 6 illustrates an example of a process flow 600 that supports antenna adaptation according to CSI-RS resource management in accordance with aspects of the present disclosure. The process flow 600 may implement or be implemented by aspects of the wireless communications system 100 or the wireless communications system 200. For example, the process flow 600 may include a base station 105-b and a UE 115-c, which may be examples of corresponding devices described with reference to FIGS. 1 and 2. In the following description of the process flow 600, some operations may be omitted from the process flow 600, and other operations may be added to the process flow: 600.

At 605, the base station 105-b may transmit, and the UE 115-c may receive, a CSI reporting configuration for a set of CSI-RS resources that correspond to a first number of antenna ports for the set of CSI-RS resources. For example, the base station 105-b may transmit, and the UE 115-c may receive, an RRC message indicating the CSI reporting configuration. At 610, the base station 105-b may transmit, and the UE 115-c may receive, control signaling indicating an antenna port configuration for a second number of antenna ports (e.g., reduced number of antenna ports) that is less than the first number of antenna ports. For example, the base station 105-b may transmit, and the UE 115-c may receive, a MAC-CE or a DCI indicating the antenna port configuration for the second number of antenna ports that is less than the first number of antenna ports.

At 615, the UE 115-c may determine a reduced number of antenna ports. For example, the UE 115-c may determine the second number of antenna ports relative to A threshold. In some examples, the UE 115-c may that the second number of antenna ports is greater than or equal to the threshold. The threshold may be a maximum number of antenna ports in a CDM group associated with the set of CSI-RS resources. Additionally or alternatively, the threshold may be a multiple of the maximum number of antenna ports in the CDM group associated with the set of CSI-RS resources. That is, the second number of antenna ports for CSI-RS is multiple of a maximum number of antenna ports in a CDM group associated with the set of CSI-RS resources.

The UE 115-c may declare (e.g., determine, indicate) an error case if the reduced number of antenna ports fail to satisfy the threshold. As a result, the UE 115-c may transmit, and the base station 105-b may receive, feedback indicating the declared error case. Otherwise, the UE 115-c may determine a subset of CSI-RS resources from the set of CSI-RS resources to use for CSI measurement and CSI reporting based on the reduced number of antenna ports. Additionally or alternatively, the UE 115-c may transmit, and the base station 105-b may receive, CSI feedback.

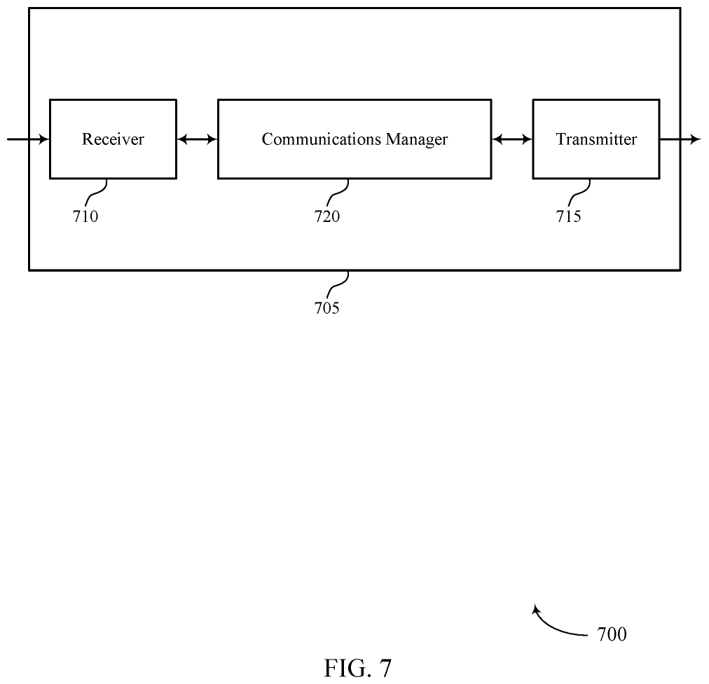

FIG. 7 shows a block diagram 700 of a device 705 that supports antenna adaptation according to CSI-RS resource management in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to antenna adaptation according to CSI-RS resource management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to antenna adaptation according to CSI-RS resource management). In some examples, the transmitter 715 may be co-located with a receiver 710 in a transceiver. The transmitter 715 may utilize a single antenna or a set of multiple antennas.

The communications manager 720, the receiver 710, the transmitter 715, or various combinations thereof or various components thereof may be examples of means for performing various aspects of antenna adaptation according to CSI-RS resource management as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at the device 705 (e.g., a UE) in accordance with examples as disclosed herein. For example, the communications manager 720 may be configured as or otherwise support a means for receiving first control signaling indicating a CSI reporting configuration for a set of CSI-RS resources that correspond to a first number of antenna ports for the set of CSI-RS resources. The communications manager 720 may be configured as or otherwise support a means for receiving second control signaling indicating an antenna port configuration for a second number of antenna ports that is less than the first number of antenna ports. The communications manager 720 may be configured as or otherwise support a means for transmitting feedback information based on the first control signaling and the second control signaling.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced power consumption.

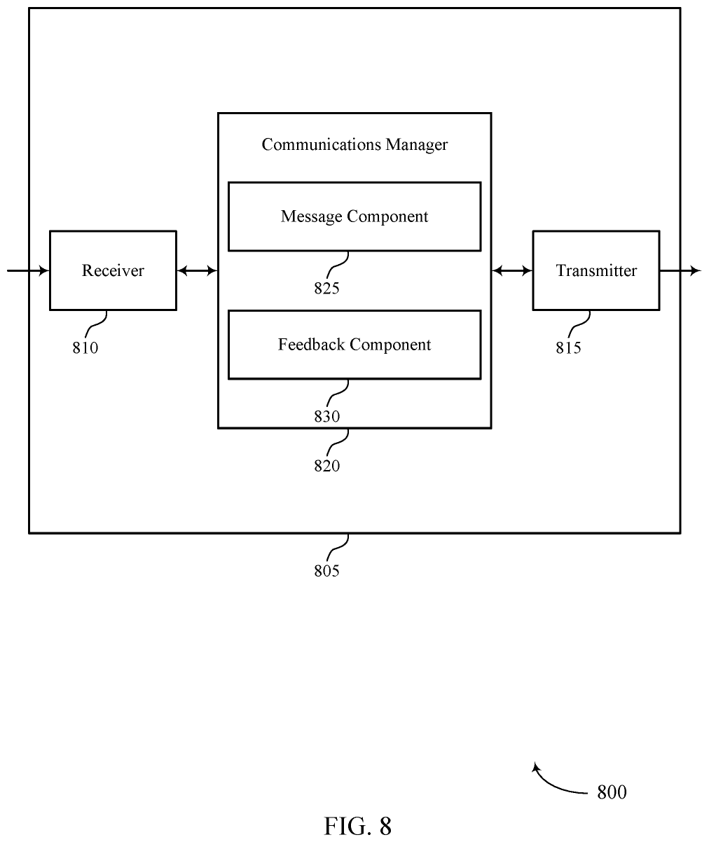

FIG. 8 shows a block diagram 800 of a device 805 that supports antenna adaptation according to CSI-RS resource management in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to antenna adaptation according to CSI-RS resource management). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to antenna adaptation according to CSI-RS resource management). In some examples, the transmitter 815 may be co-located with a receiver 810 in a transceiver. The transmitter 815 may utilize a single antenna or a set of multiple antennas.

The device 805, or various components thereof, may be an example of means for performing various aspects of antenna adaptation according to CSI-RS resource management as described herein. For example, the communications manager 820 may include a message component 825 a feedback component 830, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at the device 805 (e.g., a UE) in accordance with examples as disclosed herein. The message component 825 may be configured as or otherwise support a means for receiving first control signaling indicating a CSI reporting configuration for a set of CSI-RS resources that correspond to a first number of antenna ports for the set of CSI-RS resources. The message component 825 may be configured as or otherwise support a means for receiving second control signaling indicating an antenna port configuration for a second number of antenna ports that is less than the first number of antenna ports. The feedback component 830 may be configured as or otherwise support a means for transmitting feedback information based on the first control signaling and the second control signaling.

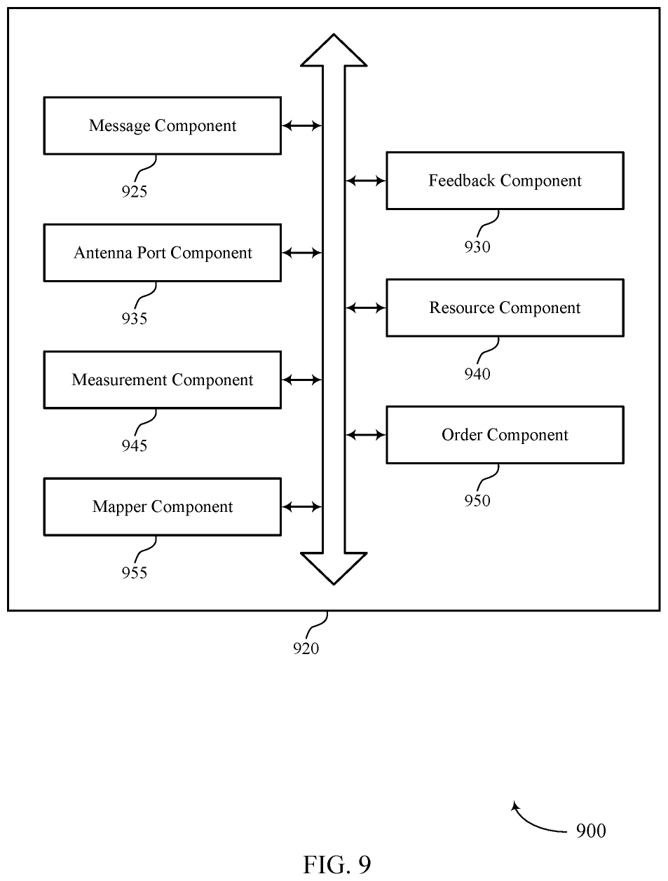

FIG. 9 shows a block diagram 900 of a communications manager 920 that supports antenna adaptation according to CSI-RS resource management in accordance with aspects of the present disclosure. The communications manager 920 may be an example of aspects of a communications manager 720, a communications manager 820, or both, as described herein. The communications manager 920, or various components thereof, may be an example of means for performing various aspects of antenna adaptation according to CSI-RS resource management as described herein. For example, the communications manager 920 may include a message component 925, a feedback component 930, an antenna port component 935, a resource component 940, a measurement component 945, an order component 950, a mapper component 955, or any combination thereof. Each of these components may communicate, directly or indirectly, with one another (e.g., via one or more buses).

The communications manager 920 may support wireless communication at a UE in accordance with examples as disclosed herein. The message component 925 may be configured as or otherwise support a means for receiving first control signaling indicating a CSI reporting configuration for a set of CSI-RS resources that correspond to a first number of antenna ports for the set of CSI-RS resources. In some examples, the message component 925 may be configured as or otherwise support a means for receiving second control signaling indicating an antenna port configuration for a second number of antenna ports that is less than the first number of antenna ports. The feedback component 930 may be configured as or otherwise support a means for transmitting feedback information based on the first control signaling and the second control signaling.

In some examples, one or both of the first control signaling or the second control signaling includes an RRC message, a MAC-CE, or a DCI, or a combination thereof. In some examples, the second number of antenna ports may correspond to CSI-RS transmissions. In some examples, the antenna port component 935 may be configured as or otherwise support a means for determining the second number of antenna ports relative to a threshold. In some examples, the feedback component 930 may be configured as or otherwise support a means for transmitting the feedback information based on comparing the second number of antenna ports relative to the threshold.

In some examples, to support determining the second number of antenna ports relative to the threshold, the antenna port component 935 may be configured as or otherwise support a means for determining that the second number of antenna ports is greater than or equal to the threshold. The threshold including a maximum number of antenna ports in a CDM group associated with the set of CSI-RS resources. In some examples, to support determining the second number of antenna ports relative to the threshold, the feedback component 930 may be configured as or otherwise support a means for transmitting the feedback information based on determining that the second number of antenna ports is greater than or equal to the threshold.

In some examples, to support determining the second number of antenna ports relative to the threshold, the antenna port component 935 may be configured as or otherwise support a means for determining that the second number of antenna ports is a multiple of a maximum number of antenna ports in a CDM group associated with the set of CSI-RS resources. In some examples, to support determining the second number of antenna ports relative to the threshold, the feedback component 930 may be configured as or otherwise support a means for transmitting the feedback information based on determining that the second number of antenna ports is the multiple of the maximum number of antenna ports in the CDM group associated with the set of CSI-RS resources.

In some examples, the resource component 940 may be configured as or otherwise support a means for determining a subset of CSI-RS resources from the set of CSI-RS resources based on an order of CDM group indices, where the subset of CSI-RS resources corresponds to the second number of antenna ports that is less than the first number of antenna ports. In some examples, the measurement component 945 may be configured as or otherwise support a means for performing a CSI measurement based on the subset of CSI-RS resources. In some examples, the feedback component 930 may be configured as or otherwise support a means for transmitting the feedback information based on the CSI measurement.

In some examples, the resource component 940 may be configured as or otherwise support a means for determining the subset of CSI-RS resources based on an increasing order of the CDM group indices. In some examples, the increasing order begins with a lowest CDM group index and ends with a highest CDM group index. In some examples, the resource component 940 may be configured as or otherwise support a means for determining the subset of CSI-RS resources based on a decreasing order of the CDM group indices. In some examples, the decreasing order begins with a highest CDM group index and ends with a lowest CDM group index. In some examples, the message component 925 may be configured as or otherwise support a means for receiving third control signaling indicating a CDM group configuration, the CDM group configuration indicating the order of CDM group indices. The third control signaling including an RRC message. In some examples, the resource component 940 may be configured as or otherwise support a means for determining the subset of CSI-RS resources from the set of CSI-RS resources based on receiving the CDM group configuration.

In some examples, the order component 950 may be configured as or otherwise support a means for determining an order of CSI-RS antenna port indices associated with the subset of CSI-RS resources, where the order begins with a lowest CSI-RS port index in a CDM group associated with the subset of CSI-RS resources. In some examples, the measurement component 945 may be configured as or otherwise support a means for performing the CSI measurement based on determining the order of CSI-RS antenna port indices associated with the subset of CSI-RS resources. In some examples, the mapper component 955 may be configured as or otherwise support a means for determining a relationship between a set of CSI-RS antenna ports and the subset of CSI-RS resources. In some examples, the measurement component 945 may be configured as or otherwise support a means for performing the CSI measurement based on determining the relationship between the set of CSI-RS antenna ports and the subset of CSI-RS resources.

In some examples, the message component 925 may be configured as or otherwise support a means for receiving third control signaling indicating at least one subset of antenna ports of a set of antenna ports associated with one or more subsets of CSI-RS resources of the set of CSI-RS resources. The third control signaling including a MAC-CE, or a DCI, or both. In some examples, the measurement component 945 may be configured as or otherwise support a means for performing a CSI measurement based on the one or more subsets of CSI-RS resources of the set of CSI-RS resources and the at least one subset of antenna ports of the set of antenna ports.

In some examples, the message component 925 may be configured as or otherwise support a means for receiving third control signaling indicating a set of multiple subset of antenna ports of a set of antenna ports associated with one or more subsets of CSI-RS resources of the set of CSI-RS resources, the third control signaling including an RRC message. In some examples, the message component 925 may be configured as or otherwise support a means for receiving fourth control signaling indicating a first selection of one or more subsets of antenna ports of the set of multiple subset of antenna ports, the fourth control signaling including a first MAC-CE. In some examples, the message component 925 may be configured as or otherwise support a means for receiving fifth control signaling indicating a second selection of at least one subset of antenna ports of the one or more subsets of antenna ports of the set of multiple subset of antenna ports, the fifth control signaling including a second MAC-CE. In some examples, the feedback component 930 may be configured as or otherwise support a means for transmitting the feedback information based on the second selection of at least one subset of antenna ports of the one or more subsets of antenna ports of the set of multiple subset of antenna ports.

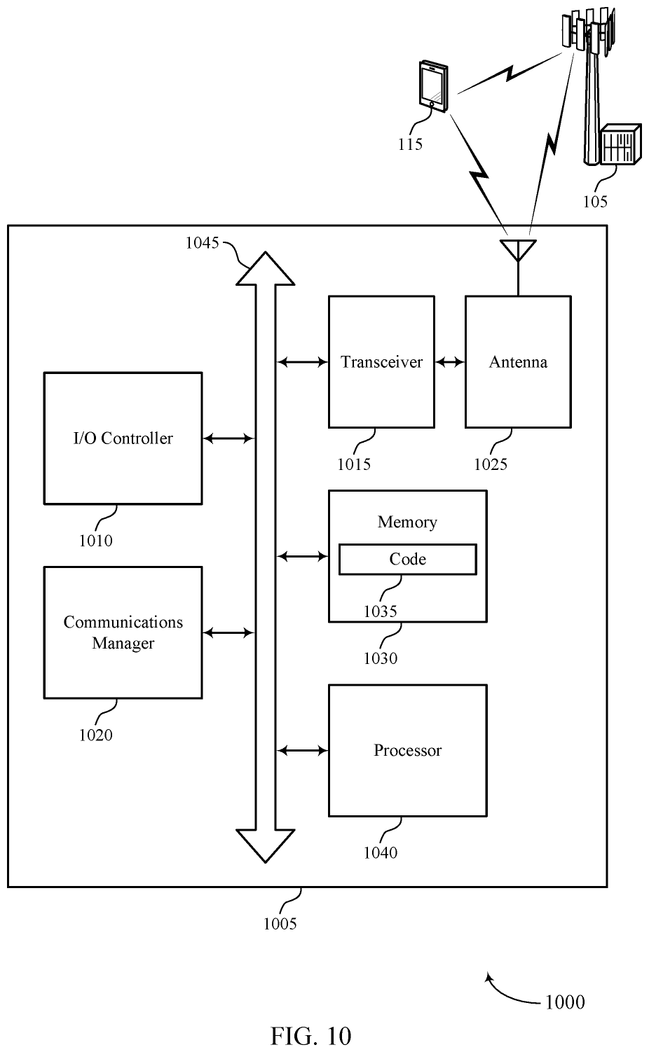

FIG. 10 shows a diagram of a system 1000 including a device 1005 that supports antenna adaptation according to CSI-RS resource management in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting antenna adaptation according to CSI-RS resource management). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at the device 1005 (e.g., a UE) in accordance with examples as disclosed herein. For example, the communications manager 1020 may be configured as or otherwise support a means for receiving first control signaling indicating a CSI reporting configuration for a set of CSI-RS resources that correspond to a first number of antenna ports for the set of CSI-RS resources. The communications manager 1020 may be configured as or otherwise support a means for receiving second control signaling indicating an antenna port configuration for a second number of antenna ports that is less than the first number of antenna ports. The communications manager 1020 may be configured as or otherwise support a means for transmitting feedback information based on the first control signaling and the second control signaling. By including or configuring the communications manager 1020 in accordance with examples as described herein, the device 1005 may support techniques for more efficient utilization of communication resources and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of antenna adaptation according to CSI-RS resource management as described herein, or the processor 1040 and the memory 1030 may be otherwise configured to perform or support such operations.

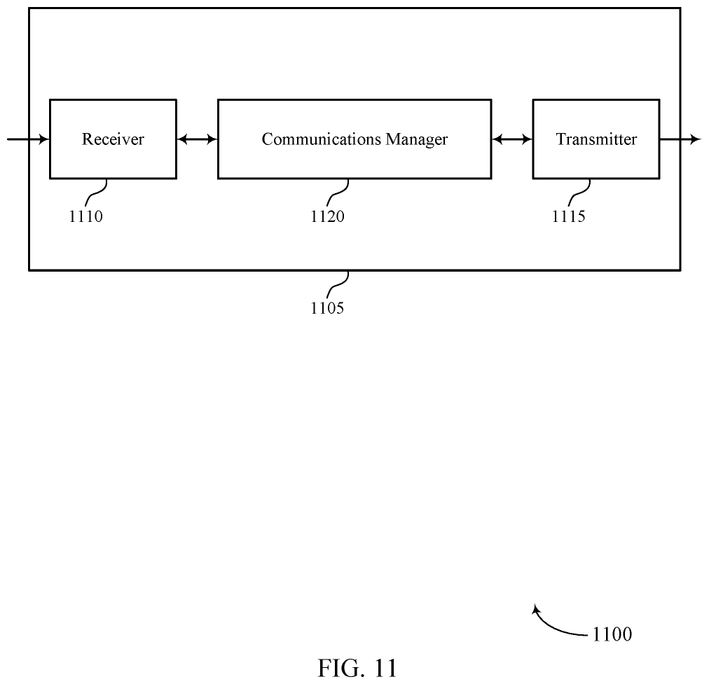

FIG. 11 shows a block diagram 1100 of a device 1105 that supports antenna adaptation according to CSI-RS resource management in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to antenna adaptation according to CSI-RS resource management). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to antenna adaptation according to CSI-RS resource management). In some examples, the transmitter 1115 may be co-located with a receiver 1110 in a transceiver. The transmitter 1115 may utilize a single antenna or a set of multiple antennas.

The communications manager 1120, the receiver 1110, the transmitter 1115, or various combinations thereof or various components thereof may be examples of means for performing various aspects of antenna adaptation according to CSI-RS resource management as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at the device 1105 (e.g., a base station) in accordance with examples as disclosed herein. For example, the communications manager 1120 may be configured as or otherwise support a means for transmitting first control signaling indicating a CSI reporting configuration for a set of CSI-RS resources that correspond to a first number of antenna ports for the set of CSI-RS resources. The communications manager 1120 may be configured as or otherwise support a means for transmitting second control signaling indicating an antenna port configuration for a second number of antenna ports that is less than the first number of antenna ports. The communications manager 1120 may be configured as or otherwise support a means for receiving feedback information based on the first control signaling and the second control signaling.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for more efficient utilization of communication resources.

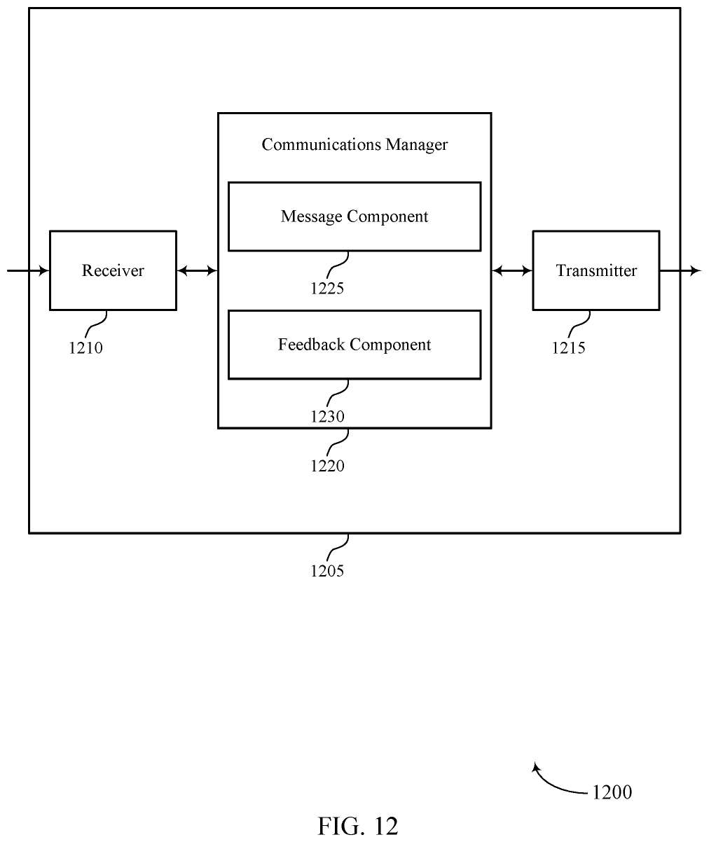

FIG. 12 shows a block diagram 1200 of a device 1205 that supports antenna adaptation according to CSI-RS resource management in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to antenna adaptation according to CSI-RS resource management). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to antenna adaptation according to CSI-RS resource management). In some examples, the transmitter 1215 may be co-located with a receiver 1210 in a transceiver. The transmitter 1215 may utilize a single antenna or a set of multiple antennas.

The device 1205, or various components thereof, may be an example of means for performing various aspects of antenna adaptation according to CSI-RS resource management as described herein. For example, the communications manager 1220 may include a message component 1225 a feedback component 1230, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at the device 1205 (e.g., a base station) in accordance with examples as disclosed herein. The message component 1225 may be configured as or otherwise support a means for transmitting first control signaling indicating a CSI reporting configuration for a set of CSI-RS resources that correspond to a first number of antenna ports for the set of CSI-RS resources. The message component 1225 may be configured as or otherwise support a means for transmitting second control signaling indicating an antenna port configuration for a second number of antenna ports that is less than the first number of antenna ports. The feedback component 1230 may be configured as or otherwise support a means for receiving feedback information based on the first control signaling and the second control signaling.

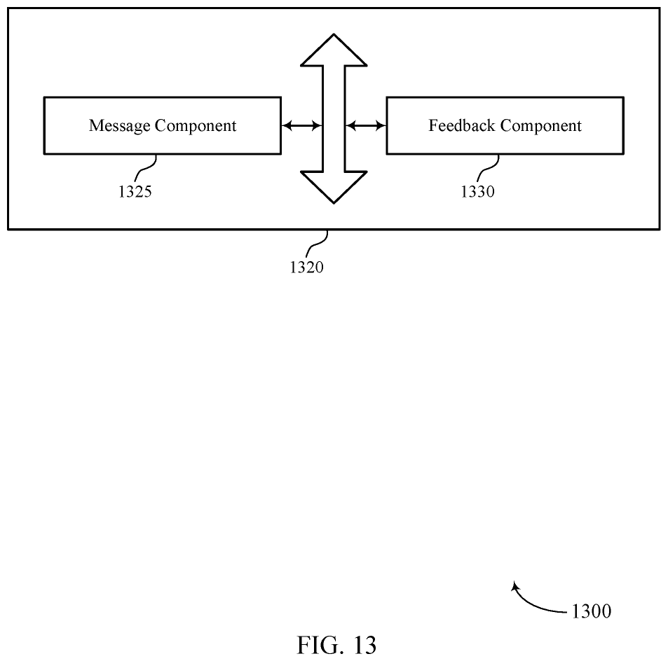

FIG. 13 shows a block diagram 1300 of a communications manager 1320 that supports antenna adaptation according to CSI-RS resource management in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of antenna adaptation according to CSI-RS resource management as described herein. For example, the communications manager 1320 may include a message component 1325 a feedback component 1330, or any combination thereof. Each of these components may communicate, directly or indirectly, with one another (e.g., via one or more buses).

The communications manager 1320 may support wireless communication at a base station in accordance with examples as disclosed herein. The message component 1325 may be configured as or otherwise support a means for transmitting first control signaling indicating a CSI reporting configuration for a set of CSI-RS resources that correspond to a first number of antenna ports for the set of CSI-RS resources. In some examples, the message component 1325 may be configured as or otherwise support a means for transmitting second control signaling indicating an antenna port configuration for a second number of antenna ports that is less than the first number of antenna ports. The feedback component 1330 may be configured as or otherwise support a means for receiving feedback information based on the first control signaling and the second control signaling. In some examples, one or both of the first control signaling and the second control signaling includes an RRC message, a MAC-CE, or a DCI, or a combination thereof. In some examples, the second number of antenna ports may correspond to CSI-RS transmissions.

In some examples, the message component 1325 may be configured as or otherwise support a means for transmitting third control signaling indicating a CDM group configuration, the CDM group configuration indicating an order of CDM group indices. In some examples, the third control signaling includes an RRC message. In some examples, the message component 1325 may be configured as or otherwise support a means for transmitting third control signaling indicating at least one subset of antenna ports of a set of antenna ports associated with one or more subsets of CSI-RS resources of the set of CSI-RS resources. In some examples, the third control signaling includes a MAC-CE, or a DCI, or both.

In some examples, the message component 1325 may be configured as or otherwise support a means for transmitting third control signaling indicating a set of multiple subset of antenna ports of a set of antenna ports associated with one or more subsets of CSI-RS resources of the set of CSI-RS resources, the third control signaling including an RRC message. In some examples, the message component 1325 may be configured as or otherwise support a means for transmitting fourth control signaling indicating a first selection of one or more subsets of antenna ports of the set of multiple subset of antenna ports, the fourth control signaling including a MAC-CE.

In some examples, the message component 1325 may be configured as or otherwise support a means for transmitting fifth control signaling indicating a second selection of at least one subset of antenna ports of the one or more subsets of antenna ports of the set of multiple subset of antenna ports, the fifth control signaling including a second MAC-CE. In some examples, the feedback component 1330 may be configured as or otherwise support a means for receiving the feedback information based on the second selection of at least one subset of antenna ports of the one or more subsets of antenna ports of the set of multiple subset of antenna ports.

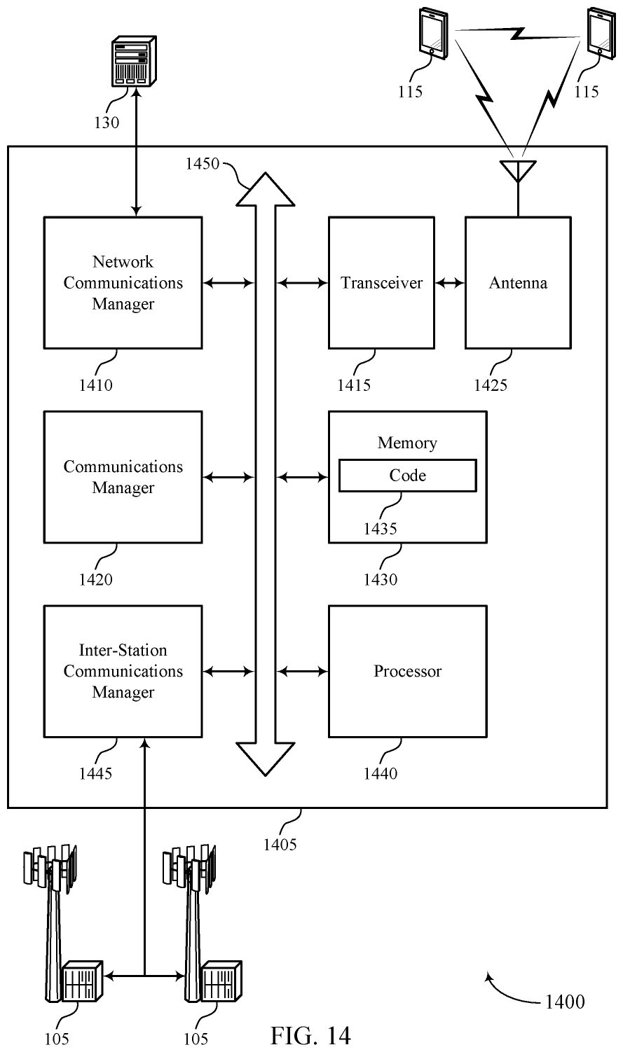

FIG. 14 shows a diagram of a system 1400 including a device 1405 that supports antenna adaptation according to CSI-RS resource management in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting antenna adaptation according to CSI-RS resource management). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at the device 1405 (e.g., a base station) in accordance with examples as disclosed herein. For example, the communications manager 1420 may be configured as or otherwise support a means for transmitting first control signaling indicating a CSI reporting configuration for a set of CSI-RS resources that correspond to a first number of antenna ports for the set of CSI-RS resources. The communications manager 1420 may be configured as or otherwise support a means for transmitting second control signaling indicating an antenna port configuration for a second number of antenna ports that is less than the first number of antenna ports. The communications manager 1420 may be configured as or otherwise support a means for receiving feedback information based on the first control signaling and the second control signaling.

By including or configuring the communications manager 1420 in accordance with examples as described herein, the device 1405 may support techniques for improved communication reliability, reduced latency, and more efficient utilization of communication resources.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of antenna adaptation according to CSI-RS resource management as described herein, or the processor 1440 and the memory 1430 may be otherwise configured to perform or support such operations.

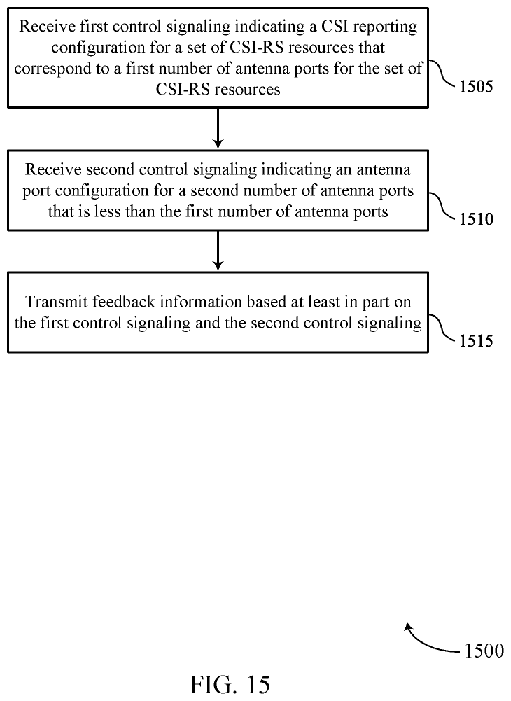

FIG. 15 shows a flowchart illustrating a method 1500 that supports antenna adaptation according to CSI-RS resource management in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, a UE may perform aspects of the described functions using special-purpose hardware.

At 1505, the method may include receiving first control signaling indicating a CSI reporting configuration for a set of CSI-RS resources that correspond to a first number of antenna ports for the set of CSI-RS resources. The operations of 1505 may be performed in accordance with examples as disclosed herein. In some examples, aspects of the operations of 1505 may be performed by a message component 925 as described with reference to FIG. 9.

At 1510, the method may include receiving second control signaling indicating an antenna port configuration for a second number of antenna ports that is less than the first number of antenna ports. The operations of 1510 may be performed in accordance with examples as disclosed herein. In some examples, aspects of the operations of 1510 may be performed by a message component 925 as described with reference to FIG. 9.

At 1515, the method may include transmitting feedback information based on the first control signaling and the second control signaling. The operations of 1515 may be performed in accordance with examples as disclosed herein. In some examples, aspects of the operations of 1515 may be performed by a feedback component 930 as described with reference to FIG. 9.

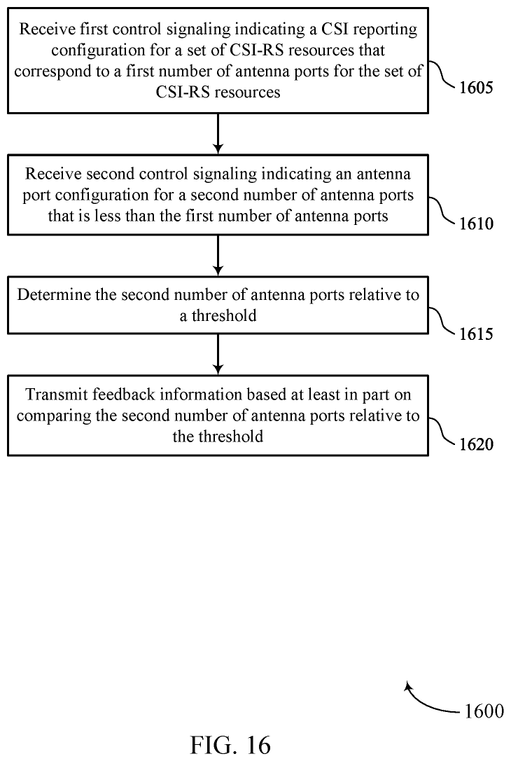

FIG. 16 shows a flowchart illustrating a method 1600 that supports antenna adaptation according to CSI-RS resource management in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, a UE may perform aspects of the described functions using special-purpose hardware.

At 1605, the method may include receiving first control signaling indicating a CSI reporting configuration for a set of CSI-RS resources that correspond to a first number of antenna ports for the set of CSI-RS resources. The operations of 1605 may be performed in accordance with examples as disclosed herein. In some examples, aspects of the operations of 1605 may be performed by a message component 925 as described with reference to FIG. 9.

At 1610, the method may include receiving second control signaling indicating an antenna port configuration for a second number of antenna ports that is less than the first number of antenna ports. The operations of 1610 may be performed in accordance with examples as disclosed herein. In some examples, aspects of the operations of 1610 may be performed by a message component 925 as described with reference to FIG. 9.

At 1615, the method may include determining the second number of antenna ports relative to a threshold. The operations of 1615 may be performed in accordance with examples as disclosed herein. In some examples, aspects of the operations of 1615 may be performed by an antenna port component 935 as described with reference to FIG. 9.

At 1620, the method may include transmitting feedback information based on comparing the second number of antenna ports relative to the threshold. The operations of 1620 may be performed in accordance with examples as disclosed herein. In some examples, aspects of the operations of 1620 may be performed by a feedback component 930 as described with reference to FIG. 9.

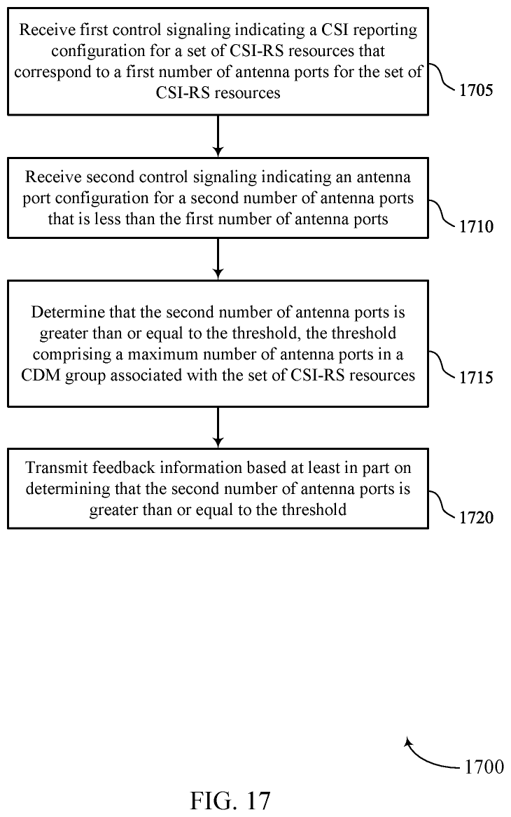

FIG. 17 shows a flowchart illustrating a method 1700 that supports antenna adaptation according to CSI-RS resource management in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, a UE may perform aspects of the described functions using special-purpose hardware.

At 1705, the method may include receiving first control signaling indicating a CSI reporting configuration for a set of CSI-RS resources that correspond to a first number of antenna ports for the set of CSI-RS resources. The operations of 1705 may be performed in accordance with examples as disclosed herein. In some examples, aspects of the operations of 1705 may be performed by a message component 925 as described with reference to FIG. 9.

At 1710, the method may include receiving second control signaling indicating an antenna port configuration for a second number of antenna ports that is less than the first number of antenna ports. The operations of 1710 may be performed in accordance with examples as disclosed herein. In some examples, aspects of the operations of 1710 may be performed by a message component 925 as described with reference to FIG. 9.

At 1715, the method may include determining that the second number of antenna ports is greater than or equal to the threshold, the threshold including a maximum number of antenna ports in a CDM group associated with the set of CSI-RS resources. The operations of 1715 may be performed in accordance with examples as disclosed herein. In some examples, aspects of the operations of 1715 may be performed by an antenna port component 935 as described with reference to FIG. 9.

At 1720, the method may include transmitting feedback information based on determining that the second number of antenna ports is greater than or equal to the threshold. The operations of 1720 may be performed in accordance with examples as disclosed herein. In some examples, aspects of the operations of 1720 may be performed by a feedback component 930 as described with reference to FIG. 9.

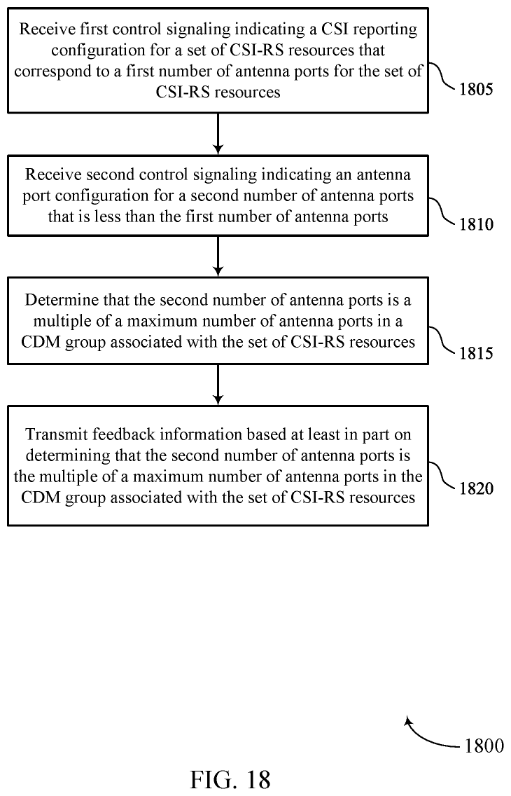

FIG. 18 shows a flowchart illustrating a method 1800 that supports antenna adaptation according to CSI-RS resource management in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally or alternatively, a UE may perform aspects of the described functions using special-purpose hardware.

At 1805, the method may include receiving first control signaling indicating a CSI reporting configuration for a set of CSI-RS resources that correspond to a first number of antenna ports for the set of CSI-RS resources. The operations of 1805 may be performed in accordance with examples as disclosed herein. In some examples, aspects of the operations of 1805 may be performed by a message component 925 as described with reference to FIG. 9.

At 1810, the method may include receiving second control signaling indicating an antenna port configuration for a second number of antenna ports that is less than the first number of antenna ports. The operations of 1810 may be performed in accordance with examples as disclosed herein. In some examples, aspects of the operations of 1810 may be performed by a message component 925 as described with reference to FIG. 9.

At 1815, the method may include determining that the second number of antenna ports is a multiple of a maximum number of antenna ports in a CDM group associated with the set of CSI-RS resources. The operations of 1815 may be performed in accordance with examples as disclosed herein. In some examples, aspects of the operations of 1815 may be performed by an antenna port component 935 as described with reference to FIG. 9.

At 1820, the method may include transmitting feedback information based on determining that the second number of antenna ports is the multiple of the maximum number of antenna ports in the CDM group associated with the set of CSI-RS resources. The operations of 1820 may be performed in accordance with examples as disclosed herein. In some examples, aspects of the operations of 1820 may be performed by a feedback component 930 as described with reference to FIG. 9.

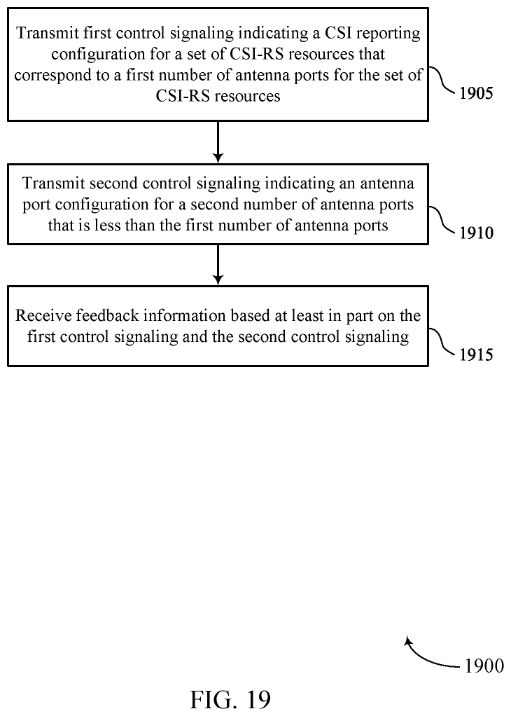

FIG. 19 shows a flowchart illustrating a method 1900 that supports antenna adaptation according to CSI-RS resource management in accordance with aspects of the present disclosure. The operations of the method 1900 may be implemented by a base station or its components as described herein. For example, the operations of the method 1900 may be performed by a base station 105 as described with reference to FIGS. 1 through 6 and 11 through 14. In some examples, a base station may execute a set of instructions to control the functional elements of the base station to perform the described functions. Additionally or alternatively, a base station may perform aspects of the described functions using special-purpose hardware.

At 1905, the method may include transmitting first control signaling indicating a CSI reporting configuration for a set of CSI-RS resources that correspond to a first number of antenna ports for the set of CSI-RS resources. The operations of 1905 may be performed in accordance with examples as disclosed herein. In some examples, aspects of the operations of 1905 may be performed by a message component 1325 as described with reference to FIG. 13.

At 1910, the method may include transmitting second control signaling indicating an antenna port configuration for a second number of antenna ports that is less than the first number of antenna ports. The operations of 1910 may be performed in accordance with examples as disclosed herein. In some examples, aspects of the operations of 1910 may be performed by a message component 1325 as described with reference to FIG. 13.

At 1915, the method may include receiving feedback information based on the first control signaling and the second control signaling. The operations of 1915 may be performed in accordance with examples as disclosed herein. In some examples, aspects of the operations of 1915 may be performed by a feedback component 1330 as described with reference to FIG. 13.

The following provides an overview of aspects of the present disclosure:

Aspect 1: A method for wireless communication at a UE, comprising: receiving first control signaling indicating a CSI reporting configuration for a set of CSI-RS resources that correspond to a first number of antenna ports for the set of CSI-RS resources: receiving second control signaling indicating an antenna port configuration for a second number of antenna ports that is less than the first number of antenna ports; and transmitting feedback information based at least in part on the first control signaling and the second control signaling.

Aspect 2: The method of aspect 1, further comprising: determining the second number of antenna ports relative to a threshold, wherein transmitting the feedback information is further based at least in part on comparing the second number of antenna ports relative to the threshold.

Aspect 3: The method of aspect 2, wherein determining the second number of antenna ports relative to the threshold comprises: determining that the second number of antenna ports is greater than or equal to the threshold, the threshold comprising a maximum number of antenna ports in a CDM group associated with the set of CSI-RS resources, wherein transmitting the feedback information is further based at least in part on determining that the second number of antenna ports is greater than or equal to the threshold.

Aspect 4: The method of any of aspects 2 through 3, wherein determining the second number of antenna ports relative to the threshold comprises: determining that the second number of antenna ports is greater than or equal to the threshold, the threshold comprising a multiple of a maximum number of antenna ports in a CDM group associated with the set of CSI-RS resources, wherein transmitting the feedback information is further based at least in part on determining that the second number of antenna ports is greater than or equal to the threshold.

Aspect 5: The method of any of aspects 1 through 4, further comprising: determining a subset of CSI-RS resources from the set of CSI-RS resources based at least in part on an order of CDM group indices, wherein the subset of CSI-RS resources corresponds to the second number of antenna ports that is less than the first number of antenna ports; and performing a CSI measurement based at least in part on the subset of CSI-RS resources, wherein transmitting the feedback information is further based at least in part on the CSI measurement.

Aspect 6: The method of aspect 5, wherein determining the subset of CSI-RS resources is based at least in part on an increasing order of the CDM group indices, and the increasing order begins with a lowest CDM group index and ends with a highest CDM group index.

Aspect 7: The method of any of aspects 5 through 6, wherein determining the subset of CSI-RS resources is based at least in part on a decreasing order of the CDM group indices, and the decreasing order begins with a highest CDM group index and ends with a lowest CDM group index.

Aspect 8: The method of any of aspects 5 through 7, further comprising: receiving third control signaling indicating a CDM group configuration, the CDM group configuration indicating the order of CDM group indices, the third control signaling comprising an RRC message, wherein determining the subset of CSI-RS resources from the set of CSI-RS resources is further based at least in part on receiving the CDM group configuration.

Aspect 9: The method of any of aspects 5 through 8, further comprising: determining an order of CSI-RS antenna port indices associated with the subset of CSI-RS resources, wherein the order begins with a lowest CSI-RS port index in a CDM group associated with the subset of CSI-RS resources, wherein performing the CSI measurement is further based at least in part on determining the order of CSI-RS antenna port indices associated with the subset of CSI-RS resources.

Aspect 10: The method of any of aspects 5 through 9, further comprising: determining a relationship between a set of CSI-RS antenna ports and the subset of CSI-RS resources, wherein performing the CSI measurement is further based at least in part on determining the relationship between the set of CSI-RS antenna ports and the subset of CSI-RS resources.

Aspect 11: The method of any of aspects 1 through 10, further comprising: receiving third control signaling indicating at least one subset of antenna ports of a set of antenna ports associated with one or more subset of CSI-RS resources of the set of CSI-RS resources, the third control signaling comprising a MAC-CE, or a DCI, or both; and performing a CSI measurement based at least in part on the one or more subset of CSI-RS resources of the set of CSI-RS resources and the at least one subset of antenna ports of the set of antenna ports.

Aspect 12: The method of any of aspects 1 through 11, further comprising: receiving third control signaling indicating a plurality of subset of antenna ports of a set of antenna ports associated with one or more subset of CSI-RS resources of the set of CSI-RS resources, the third control signaling comprising an RRC message: receiving fourth control signaling indicating a first selection of one or more subset of antenna ports of the plurality of subset of antenna ports, the fourth control signaling comprising a first MAC-CE; and receiving fifth control signaling indicating a second selection of at least one subset of antenna ports of the one or more subset of antenna ports of the plurality of subset of antenna ports, the fifth control signaling comprising a second MAC-CE, wherein transmitting the feedback information is further based at least in part on the second selection of at least one subset of antenna ports of the one or more subset of antenna ports of the plurality of subset of antenna ports.

Aspect 13: The method of any of aspects 1 through 12, wherein one or both of the first control signaling and the second control signaling comprises RRC message, a MAC-CE, or a DCI, or a combination thereof.

Aspect 14: The method of any of aspects 1 through 13, wherein the second number of antenna ports correspond to CSI-RS transmissions.

Aspect 15: A method for wireless communication at a base station, comprising: transmitting first control signaling indicating a CSI reporting configuration for a set of CSI-RS resources that correspond to a first number of antenna ports for the set of CSI-RS resources: transmitting second control signaling indicating an antenna port configuration for a second number of antenna ports that is less than the first number of antenna ports; and receiving feedback information based at least in part on the first control signaling and the second control signaling.

Aspect 16: The method of aspect 15, further comprising: transmitting third control signaling indicating a CDM group configuration, the CDM group configuration indicating an order of CDM group indices.

Aspect 17: The method of aspect 16, wherein the third control signaling comprises an RRC message.

Aspect 18: The method of any of aspects 15 through 17, further comprising: transmitting third control signaling indicating at least one subset of antenna ports of a set of antenna ports associated with one or more subset of CSI-RS resources of the set of CSI-RS resources.

Aspect 19: The method of aspect 18, wherein the third control signaling comprises a MAC-CE, or a DCI, or both.

Aspect 20: The method of any of aspects 15 through 19, further comprising: transmitting third control signaling indicating a plurality of subset of antenna ports of a set of antenna ports associated with one or more subset of CSI-RS resources of the set of CSI-RS resources, the third control signaling comprising an RRC message: transmitting fourth control signaling indicating a first selection of one or more subset of antenna ports of the plurality of subset of antenna ports, the fourth control signaling comprising a MAC-CE; and transmitting fifth control signaling indicating a second selection of at least one subset of antenna ports of the one or more subset of antenna ports of the plurality of subset of antenna ports, the fifth control signaling comprising a second MAC-CE, wherein receiving the feedback information is further based at least in part on the second selection of at least one subset of antenna ports of the one or more subset of antenna ports of the plurality of subset of antenna ports.

Aspect 21: The method of any of aspects 15 through 20, wherein one or both of the first control signaling and the second control signaling comprises RRC message, a MAC-CE, or a DCI, or a combination thereof.

Aspect 22: The method of any of aspects 15 through 21, wherein the second number of antenna ports correspond to CSI-RS transmissions.

Aspect 23: An apparatus for wireless communication at a UE, comprising a processor: memory coupled with the processor; and instructions stored in the memory and executable by the processor to cause the apparatus to perform a method of any of aspects 1 through 14.

Aspect 24: An apparatus for wireless communication at a UE, comprising at least one means for performing a method of any of aspects 1 through 14.

Aspect 25: A non-transitory computer-readable medium storing code for wireless communication at a UE, the code comprising instructions executable by a processor to perform a method of any of aspects 1 through 14.

Aspect 26: An apparatus for wireless communication at a base station, comprising a processor: memory coupled with the processor; and instructions stored in the memory and executable by the processor to cause the apparatus to perform a method of any of aspects 15 through 22.

Aspect 27: An apparatus for wireless communication at a base station, comprising at least one means for performing a method of any of aspects 15 through 22.

Aspect 28: A non-transitory computer-readable medium storing code for wireless communication at a base station, the code comprising instructions executable by a processor to perform a method of any of aspects 15 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first control signaling indicating a channel state information reporting configuration for a set of channel state information reference signal resources that correspond to a first number of antenna ports for the set of channel state information reference signal resources;
receiving second control signaling indicating an antenna port configuration for a second number of antenna ports that is less than the first number of antenna ports; and
transmitting feedback information based at least in part on the first control signaling and the second control signaling.

2. The method of claim 1, further comprising:
determining the second number of antenna ports relative to a threshold,
wherein transmitting the feedback information is further based at least in part on comparing the second number of antenna ports relative to the threshold.

3. The method of claim 2, wherein determining the second number of antenna ports relative to the threshold comprises:
determining that the second number of antenna ports is greater than or equal to the threshold, the threshold comprising a maximum number of antenna ports in a code division multiplexing group associated with the set of channel state information reference signal resources,
wherein transmitting the feedback information is further based at least in part on determining that the second number of antenna ports is greater than or equal to the threshold.

4. The method of claim 1, further comprising:
determining that the second number of antenna ports is a multiple of a maximum number of antenna ports in a code division multiplexing group associated with the set of channel state information reference signal resources,
wherein transmitting the feedback information is further based at least in part on determining that the second number of antenna ports is the multiple of the maximum number of antenna ports in the code division multiplexing group associated with the set of channel state information reference signal resources.

5. The method of claim 1, further comprising:
determining a subset of channel state information reference signal resources from the set of channel state information reference signal resources based at least in part on an order of code division multiplexing group indices, wherein the subset of channel state information reference signal resources corresponds to the second number of antenna ports that is less than the first number of antenna ports; and
performing a channel state information measurement based at least in part on the subset of channel state information reference signal resources,
wherein transmitting the feedback information is further based at least in part on the channel state information measurement.

6. The method of claim 5, wherein determining the subset of channel state information reference signal resources is based at least in part on an increasing order of the code division multiplexing group indices, and the increasing order begins with a lowest code division multiplexing group index and ends with a highest code division multiplexing group index.

7. The method of claim 5, wherein determining the subset of channel state information reference signal resources is based at least in part on a decreasing order of the code division multiplexing group indices, and the decreasing order begins with a highest code division multiplexing group index and ends with a lowest code division multiplexing group index.

8. The method of claim 5, further comprising:
receiving third control signaling indicating a code division multiplexing group configuration, the code division multiplexing group configuration indicating the order of code division multiplexing group indices, the third control signaling comprising a radio resource control message,
wherein determining the subset of channel state information reference signal resources from the set of channel state information reference signal resources is further based at least in part on receiving the code division multiplexing group configuration.

9. The method of claim 5, further comprising:
determining an order of channel state information reference signal antenna port indices associated with the subset of channel state information reference signal resources, wherein the order of channel state information reference signal antenna port indices begins with a lowest channel state information reference signal port index in a code division multiplexing group associated with the subset of channel state information reference signal resources,
wherein performing the channel state information measurement is further based at least in part on determining the order of channel state information reference signal antenna port indices associated with the subset of channel state information reference signal resources.

10. The method of claim 5, further comprising:
determining a relationship between a set of channel state information reference signal antenna ports and the subset of channel state information reference signal resources,
wherein performing the channel state information measurement is further based at least in part on determining the relationship between the set of channel state information reference signal antenna ports and the subset of channel state information reference signal resources.

11. The method of claim 1, further comprising:
receiving third control signaling indicating at least one subset of antenna ports of a set of antenna ports associated with one or more subsets of channel state information reference signal resources of the set of channel state information reference signal resources, the third control signaling comprising a medium access control-control element, or a downlink control information, or both; and
performing a channel state information measurement based at least in part on the one or more subsets of channel state information reference signal resources of the set of channel state information reference signal resources and the at least one subset of antenna ports of the set of antenna ports.

12. The method of claim 1, further comprising:
receiving third control signaling indicating a plurality of subset of antenna ports of a set of antenna ports associated with one or more subsets of channel state information reference signal resources of the set of channel state information reference signal resources, the third control signaling comprising a radio resource control message;
receiving fourth control signaling indicating a first selection of one or more subsets of antenna ports of the plurality of subset of antenna ports, the fourth control signaling comprising a first medium access control-control element; and
receiving fifth control signaling indicating a second selection of at least one subset of antenna ports of the one or more subsets of antenna ports of the plurality of subset of antenna ports, the fifth control signaling comprising a second medium access control-control element,
wherein transmitting the feedback information is further based at least in part on the second selection of at least one subset of antenna ports of the one or more subsets of antenna ports of the plurality of subset of antenna ports.

13. The method of claim 1, wherein one or both of the first control signaling and the second control signaling comprises radio resource control message, a medium access control-control element, or a downlink control information, or a combination thereof.

14. The method of claim 1, wherein the second number of antenna ports correspond to channel state information reference signal transmissions.

15. A method for wireless communication at a base station, comprising:
transmitting first control signaling indicating a channel state information reporting configuration for a set of channel state information reference signal resources that correspond to a first number of antenna ports for the set of channel state information reference signal resources;
transmitting second control signaling indicating an antenna port configuration for a second number of antenna ports that is less than the first number of antenna ports; and
receiving feedback information based at least in part on the first control signaling and the second control signaling.

16. The method of claim 15, further comprising:
transmitting third control signaling indicating a code division multiplexing group configuration, the code division multiplexing group configuration indicating an order of code division multiplexing group indices.

17. The method of claim 16, wherein the third control signaling comprises a radio resource control message.

18. The method of claim 15, further comprising:
transmitting third control signaling indicating at least one subset of antenna ports of a set of antenna ports associated with one or more subsets of channel state information reference signal resources of the set of channel state information reference signal resources.

19. The method of claim 18, wherein the third control signaling comprises a medium access control-control element, or a downlink control information, or both.

20. The method of claim 15, further comprising:
transmitting third control signaling indicating a plurality of subset of antenna ports of a set of antenna ports associated with one or more subsets of channel state information reference signal resources of the set of channel state information reference signal resources, the third control signaling comprising a radio resource control message;
transmitting fourth control signaling indicating a first selection of one or more subsets of antenna ports of the plurality of subset of antenna ports, the fourth control signaling comprising a medium access control-control element; and
transmitting fifth control signaling indicating a second selection of at least one subset of antenna ports of the one or more subsets of antenna ports of the plurality of subset of antenna ports, the fifth control signaling comprising a second medium access control-control element,
wherein receiving the feedback information is further based at least in part on the second selection of at least one subset of antenna ports of the one or more subsets of antenna ports of the plurality of subset of antenna ports.

21. The method of claim 15, wherein one or both of the first control signaling and the second control signaling comprises radio resource control message, a medium access control-control element, or a downlink control information, or a combination thereof.

22. The method of claim 15, wherein the second number of antenna ports correspond to channel state information reference signal transmissions.

23. An apparatus for wireless communication, comprising:
a processor;
memory coupled with the processor; and
instructions stored in the memory and executable by the processor to cause the apparatus to:
receive first control signaling indicating a channel state information reporting configuration for a set of channel state information reference signal resources that correspond to a first number of antenna ports for the set of channel state information reference signal resources;
receive second control signaling indicating an antenna port configuration for a second number of antenna ports that is less than the first number of antenna ports; and
transmit feedback information based at least in part on the first control signaling and the second control signaling.

24. The apparatus of claim 23, wherein the instructions are further executable by the processor to cause the apparatus to:
determine the second number of antenna ports relative to a threshold,
wherein to transmit the feedback information is further based at least in part on comparing the second number of antenna ports relative to the threshold.

25. The apparatus of claim 24, wherein the instructions to determine the second number of antenna ports relative to the threshold are executable by the processor to cause the apparatus to:
determine that the second number of antenna ports is greater than or equal to the threshold, the threshold comprising a maximum number of antenna ports in a code division multiplexing group associated with the set of channel state information reference signal resources,
wherein to transmit the feedback information is further based at least in part on determining that the second number of antenna ports is greater than or equal to the threshold.

26. The apparatus of claim 23, wherein the instructions are further executable by the processor to cause the apparatus to:
determine that the second number of antenna ports is a multiple of a maximum number of antenna ports in a code division multiplexing group associated with the set of channel state information reference signal resources,
wherein to transmit the feedback information is further based at least in part on that the second number of antenna ports is the multiple of a maximum number of antenna ports in the code division multiplexing group associated with the set of channel state information reference signal resources.

27. The apparatus of claim 23, wherein the instructions are further executable by the processor to cause the apparatus to:
determine a subset of channel state information reference signal resources from the set of channel state information reference signal resources based at least in part on an order of code division multiplexing group indices, wherein the subset of channel state information reference signal resources corresponds to the second number of antenna ports that is less than the first number of antenna ports; and
perform a channel state information measurement based at least in part on the subset of channel state information reference signal resources,
wherein to transmit the feedback information is further based at least in part on the channel state information measurement.

28. The apparatus of claim 27, wherein to determine the subset of channel state information reference signal resources is based at least in part on an increasing order of the code division multiplexing group indices, and the increasing order begins with a lowest code division multiplexing group index and ends with a highest code division multiplexing group index.

29. The apparatus of claim 27, wherein to determine the subset of channel state information reference signal resources is based at least in part on a decreasing order of the code division multiplexing group indices, and the decreasing order begins with a highest code division multiplexing group index and ends with a lowest code division multiplexing group index.

30. An apparatus for wireless communication, comprising:
a processor;
memory coupled with the processor; and
instructions stored in the memory and executable by the processor to cause the apparatus to:
transmit first control signaling indicating a channel state information reporting configuration for a set of channel state information reference signal resources that correspond to a first number of antenna ports for the set of channel state information reference signal resources;
transmit second control signaling indicating an antenna port configuration for a second number of antenna ports that is less than the first number of antenna ports; and
receive feedback information based at least in part on the first control signaling and the second control signaling.
